(19) United States
(12) Patent Application Publication
(10) Pub. No.: US 2026/0011236 A1
(43) Pub. Date: Jan. 8, 2026

(54) LAVATORY CONTROL SYSTEM

(71) Applicant: TOTO LTD., Kitakyushu-shi (JP)

(72) Inventors: Yoshihiro Sugita, Fukuoka (JP); Tetsuhiro Wasada, Fukuoka (JP); Koki Nomura, Fukuoka (JP); Masamichi Tosaki, Fukuoka (JP); Hiroshi Tsuboi, Fukuoka (JP)

(21) Appl. No.: 19/325,579

(22) Filed: Sep. 11, 2025

Related U.S. Application Data
(63) Continuation of application No. PCT/JP2024/008517, filed on Mar. 6, 2024.

(30) Foreign Application Priority Data
Mar. 28, 2023 (JP) 2023-051659
Mar. 28, 2023 (JP) 2023-051660
Mar. 22, 2024 (JP) 2024-045989

(51) Int. Cl. G08B 21/18; E03D 9/00

(52) U.S. Cl. CPC G08B 21/18; E03D 9/00

(57) ABSTRACT

A lavatory control system according to an embodiment includes an input terminal configured to receive an input from a cleaner in charge of performing sanitary work on at least one toilet room among a plurality of toilet rooms; and a controller configured to perform control to cause, when information related to sanitary work progress of a toilet room is input to the input terminal, a display to display usage recommendation information that recommends or does not recommend use of the toilet room for which the information mentioned above has been input.

### TECHNICAL FIELD

Embodiments of the disclosure relate to a lavatory control system.

### BACKGROUND ART

A system configured to appropriately manage sanitary work of a plurality of toilet chambers (toilet spaces) and the like is known (for example, Patent Document 1). For example, in a system described in Patent Document 1, timings at which sanitary work is performed on a plurality of toilet chambers are determined based on a use status of toilet bowl devices.

### CITATION LIST

### Patent Literature

Patent Document 1: JP 2019-141307 A

### SUMMARY OF INVENTION

### Technical Problem

However, there is room for improvement in the above technology. For example, in the above-described system of the related art, in a case where a sanitary work target such as a toilet room is in use when sanitary work of the toilet is desired, the sanitary work cannot be performed on the sanitary work target while the sanitary work target is in use. Accordingly, for example, while one toilet room is being subjected to sanitary work, in a case where a person (user) enters another toilet room scheduled to be subjected to sanitary work next, even when the sanitary work of the one toilet room has been completed, a state is brought about in which the sanitary work of the other toilet room cannot be started until the use of the other toilet room has ended. Therefore, in the above-described system of the related art, although a sanitary work timing can be determined, depending on a toilet usage manner of the user, a situation may arise in which the sanitary work cannot be performed on the sanitary work target at the determined sanitary work timing. Thus, it is desirable that the user be guided to use the toilet in a desired manner.

In light of the above points, the challenge is to guide a user to use a toilet in a desired manner.

An object of an embodiment of the disclosure is to provide a lavatory control system that can guide a user to use a toilet in a desired manner.

### Solution to Problem

A lavatory control system according to an aspect of an embodiment includes: an input terminal configured to receive an input from a cleaner in charge of performing sanitary work on at least one toilet room among a plurality of toilet rooms; and a controller configured to perform control to cause, when information related to sanitary work progress of a toilet room is input to the input terminal, a display to display usage recommendation information that recommends or does not recommend use of the toilet room for which the information mentioned above has been input.

In the lavatory control system according to the aspect of the embodiment, since the status of the toilet room can be indicated by displaying whether the use of the toilet room is recommended or not, it is possible to prompt a toilet user to use the above toilet room or to use another toilet room without discomforting the user. Thus, the lavatory control system can guide the user to use the toilet in a desired manner.

In the lavatory control system according to an aspect of the embodiment, when sanitary work completion information of a toilet room is input to the input terminal, the controller performs control to cause a display to display usage recommendation information that recommends use of a target toilet room that is the toilet room for which the sanitary work completion information has been input.

In the lavatory control system according to the aspect of the embodiment, since the toilet room recommended for use upon completion of the sanitary work is indicated, it is possible to prompt a toilet user to use the toilet room for which sanitary work has been performed without discomforting the toilet user. Thus, the lavatory control system can guide the user to use the toilet in a desired manner.

The lavatory control system according to an aspect of the embodiment further includes a plurality of displays each installed for corresponding ones of the plurality of toilet rooms, wherein the controller performs control to cause the display corresponding to the target toilet room among the plurality of displays to display the usage recommendation information.

In the lavatory control system according to the aspect of the embodiment, since a toilet room recommended for use is indicated by the display performed by the display installed corresponding to the toilet room, it is possible to prompt a toilet user to use the toilet room for which sanitary work has been performed without discomforting the toilet user. Thus, the lavatory control system can guide the user to use the toilet in a desired manner.

In the lavatory control system according to an aspect of the embodiment, the controller performs control to cancel the display of the usage recommendation information by the display upon an elapse of a predetermined time from the start of the display.

In the lavatory control system according to the aspect of the embodiment, by canceling the display upon the elapse of the predetermined time, a situation in which the display remains after the predetermined time has elapsed since the completion of sanitary work may be suppressed. Thus, the lavatory control system can guide the user to use the toilet in a desired manner. That is, it is possible to suppress a situation in which waiting time is unnecessarily extended due to the toilet room being unusable also when the number of toilet users has increased.

In the lavatory control system according to an aspect of the embodiment, the controller performs control to cancel the display of the usage recommendation information by all the displays displaying the usage recommendation information after the completion of sanitary work of the plurality of toilet rooms.

In the lavatory control system according to the aspect of the embodiment, when the sanitary work of all the toilet rooms is completed, all the displays are canceled, and thus, after the completion of sanitary work of all the toilet rooms, the user can freely use a toilet room that they like. Thus, the lavatory control system can guide the user to use the toilet in a desired manner.

In the lavatory control system according to an aspect of the embodiment, when a toilet room for which the usage recommendation information is being displayed becomes in use, the controller performs control to cancel the display of the usage recommendation information of the toilet room by the display.

In the lavatory control system according to the aspect of the embodiment, a situation in which a toilet room in use is promoted to be used may be prevented. Thus, the lavatory control system can guide the user to use the toilet in a desired manner.

In the lavatory control system according to an aspect of the embodiment, when the use of the toilet room for which the display of the usage recommendation information has been canceled has ended, the controller performs control to display again the usage recommendation information that recommends the use of the toilet room.

In the lavatory control system according to the aspect of the embodiment, the use of the toilet room after being used can be prompted again. Thus, the lavatory control system can guide the user to use the toilet in a desired manner.

A lavatory control system according to an aspect of the embodiment includes: an input terminal configured to receive an input, from a cleaner, for at least one toilet space among a plurality of the toilet spaces; and a controller configured to perform control to cause, when sanitary work completion information of a toilet space is input to the input terminal, a display to display usage recommendation information that recommends use of a target toilet space that is the toilet space for which the sanitary work completion information has been input.

In the lavatory control system according to the aspect of the embodiment, since the toilet space recommended for use upon completion of the sanitary work is indicated, it is possible to prompt a toilet user to use the toilet space having been subjected to sanitary work without discomforting the toilet user. Thus, the lavatory control system can guide the user to use the toilet in a desired manner.

In the lavatory control system according to an aspect of the embodiment, the controller performs control, when sanitary work start information of a toilet room is input to the input terminal, to cause the display to display usage non-recommendation information indicating that use of a designated toilet room that is the toilet room designated by the sanitary work start information is not recommended, and performs control to cancel the display of the usage non-recommendation information of the designated toilet room by the display when sanitary work completion information of the designated toilet room is input to the input terminal. In the lavatory control system according to the aspect of the embodiment, since a toilet room not recommended for use because sanitary work is yet to be performed is indicated, it is possible to prompt a toilet user to use another toilet room that has already been subjected to sanitary work without discomforting the toilet user. Thus, the lavatory control system can guide the user to use the toilet in a desired manner.

In the lavatory control system according to an aspect of the embodiment, based on a queue for performing the sanitary work on the plurality of toilet rooms, when sanitary work completion information of one toilet room is input to the input terminal, the controller performs control to cause the display to display usage non-recommendation information indicating that a designated toilet room that is another toilet room subsequent to the one toilet room in the queue is not recommended for use.

In the lavatory control system according to the aspect of the embodiment, when the information of sanitary work completion is acquired in accordance with the queue for performing the sanitary work set in advance, the sanitary work can be smoothly performed without the sanitary work flow being interrupted by displaying usage non-recommendation information for another toilet room. Thus, the lavatory control system can guide the user to use the toilet in a desired manner.

The lavatory control system according to an aspect of the embodiment includes a plurality of the displays each installed for a corresponding one of the plurality of toilet rooms, wherein the controller performs control to cause a display corresponding to the designated toilet room among the plurality of displays to display the usage non-recommendation information.

In the lavatory control system according to the aspect of the embodiment, since a toilet room recommended for use is indicated by the display performed by the display installed corresponding to the toilet room, it is possible to prompt a toilet user to use another toilet room that has already been subjected to sanitary work without discomforting the toilet user. Thus, the lavatory control system can guide the user to use the toilet in a desired manner.

The lavatory control system according to an aspect of the embodiment further includes a sensor configured to detect use of a toilet room, wherein when the toilet room for which the usage non-recommendation information is being displayed becomes in use, the controller performs control to cause the display to display the usage non-recommendation information indicating that use of another toilet room different from the above toilet room is not recommended.

In the lavatory control system according to the aspect of the embodiment, when a toilet room for which the usage non-recommendation information is being displayed becomes in use, the sanitary work can be smoothly performed without interrupting the sanitary work flow by displaying the usage non-recommendation information for another toilet room. Thus, the lavatory control system can guide the user to use the toilet in a desired manner.

In the lavatory control system according to an aspect of the embodiment, the controller notifies an administrator of information identifying a toilet room that needs sanitary work, and performs control to cause the display to display the usage non-recommendation information indicating that the toilet room specified by an instruction from the administrator is not recommended for use.

In the lavatory control system according to the aspect of the embodiment, the usage non-recommendation information can be collectively displayed for the rooms that need sanitary work in response to an instruction from the administrator, thereby making it possible to more efficiently perform sanitary work. Thus, the lavatory control system can guide the user to use the toilet in a desired manner.

In the lavatory control system according to an aspect of the embodiment, when a toilet room for which the usage non-recommendation information is being displayed becomes in use, the controller performs control to cancel the display of the usage non-recommendation information of the toilet room by the display.

With the lavatory control system according to the aspect of the embodiment, a situation in which an erroneous state is displayed can be suppressed. Thus, the lavatory control system can guide the user to use the toilet in a desired manner.

In the lavatory control system according to an aspect of the embodiment, when the use of the toilet room for which the display of the usage non-recommendation information has been canceled has ended, the controller performs control to display again the usage non-recommendation information that recommends the use of the toilet room. With the lavatory control system according to the aspect of the embodiment, a correct state can be displayed. Thus, the lavatory control system can guide the user to use the toilet in a desired manner.

A lavatory control system according to an aspect of the embodiment includes: an input terminal configured to receive an input from a cleaner in charge of performing sanitary work on a plurality of toilet spaces; and a controller configured to perform control to cause, when sanitary work start information of a toilet space is input to the input terminal, a display to display usage non-recommendation information indicating that use of a designated toilet space that is the toilet space designated by the sanitary work start information is not recommended, and perform control to cancel the display of the usage non-recommendation information of the designated toilet space by the display when sanitary work completion information of the designated toilet space is input to the input terminal.

In the lavatory control system according to the aspect of the embodiment, since a toilet space not recommended for use because sanitary work is yet to be performed is known, it is possible to prompt a toilet user to use another toilet space that has already been subjected to sanitary work without discomforting the toilet user. Thus, the lavatory control system can guide the user to use the toilet in a desired manner.

Advantageous Effects of Invention

According to the aspect of the embodiment, the user can be guided to use the toilet in a desired manner.

### BRIEF DESCRIPTION OF DRAWINGS

FIG. 1 is a diagram illustrating a configuration example of a toilet space according to an embodiment.

FIG. 2 is a diagram illustrating a configuration example of a toilet room according to the embodiment.

FIG. 3 is a diagram illustrating a configuration example of a lavatory control system according to the embodiment.

FIG. 4 is a block diagram illustrating a configuration example of a control device according to the embodiment.

FIG. 5 is a diagram illustrating an example of an arrangement information storage unit according to the embodiment.

FIG. 6 is a diagram illustrating an overview of processing relating to recommendation information display executed by the lavatory control system.

FIG. 7 is a flowchart illustrating an example of a procedure for processing executed by the lavatory control system.

FIG. 8 is a flowchart illustrating an example of a procedure for processing executed by the lavatory control system.

FIG. 9 is a diagram illustrating an example of a mode for receiving an input related to sanitary work progress.

FIG. 10 is a flowchart illustrating an example of a procedure for processing executed by the lavatory control system.

FIG. 11 is a flowchart illustrating an example of a procedure for processing executed by the lavatory control system.

FIG. 12 is a flowchart illustrating an example of a procedure for processing executed by the lavatory control system.

FIG. 13 is a diagram illustrating an example of a mode for receiving an input related to sanitary work progress.

FIG. 14 is a diagram illustrating an overview of processing relating to non-recommendation information display executed by the lavatory control system.

FIG. 15 is a flowchart illustrating an example of a procedure for processing executed by the lavatory control system.

FIG. 16 is a flowchart illustrating an example of a procedure for processing executed by the lavatory control system.

FIG. 17 is a flowchart illustrating an example of a procedure for processing executed by the lavatory control system.

FIG. 18 is a diagram illustrating an example of a mode for receiving an input related to sanitary work progress.

FIG. 19 is a flowchart illustrating an example of a procedure for processing executed by the lavatory control system.

FIG. 20 is a flowchart illustrating an example of a procedure for processing executed by the lavatory control system.

FIG. 21 is a flowchart illustrating an example of a procedure for processing executed by the lavatory control system.

FIG. 22 is a diagram illustrating an example of a mode for receiving an input related to sanitary work progress.

FIG. 23 is a flowchart illustrating an example of a procedure for processing executed by the lavatory control system.

FIG. 24 is a flowchart illustrating an example of a procedure for processing executed by the lavatory control system.

FIG. 25 is a flowchart illustrating an example of a procedure for processing executed by the lavatory control system.

FIG. 26 is a diagram illustrating an example of a mode for receiving an input related to sanitary work progress.

FIG. 27 is a diagram illustrating an overview of processing relating to display of recommendation information and non-recommendation information executed by the lavatory control system.

### DESCRIPTION OF EMBODIMENTS

Embodiments of a lavatory control system disclosed in the present application will be described below in detail with reference to the accompanying drawings. Note that the present invention is not limited to the embodiments described below.

### 1. Embodiment

### 1-1. Configuration Example of Toilet Space

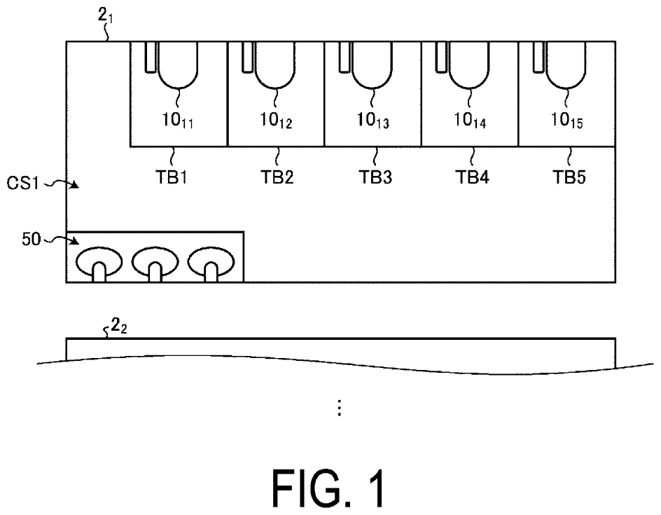

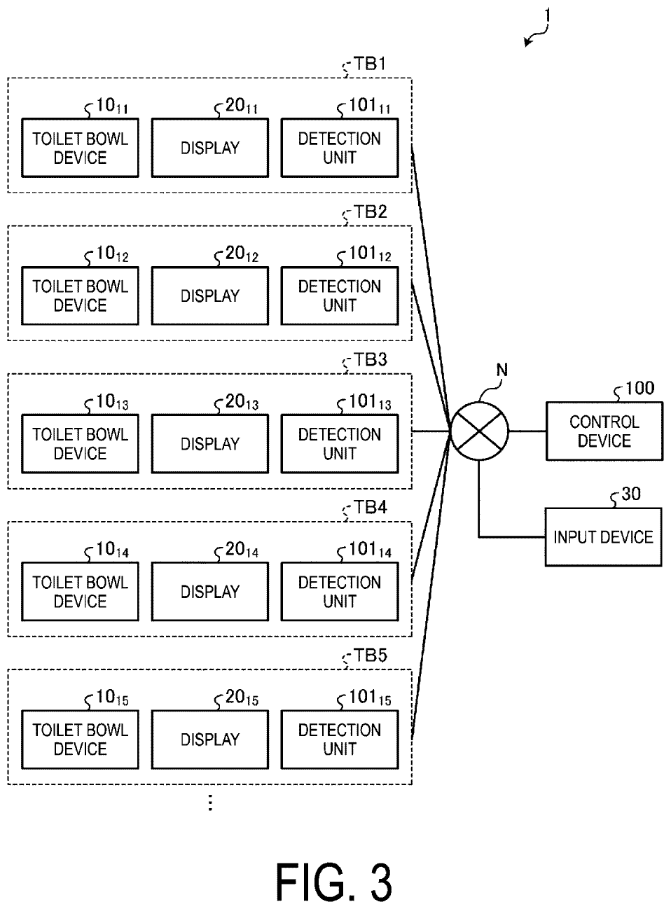

Prior to description of processing executed in a lavatory control system 1 (see FIG. 3) according to an embodiment, a configuration example of a toilet space (toilet chamber) will be described with reference to FIG. 1. FIG. 1 is a diagram illustrating a configuration example of a toilet space according to the embodiment. FIG. 1 conceptually illustrates the physical arrangement and the like of the toilet space.

Hereinafter, a case will be described as an example in which targets (sanitary work targets) for which a person in charge of sanitary work (cleaner) of a toilet performs sanitary work are five toilet rooms TB in a toilet space 2₁, but the sanitary work targets are not limited to the toilet rooms TB and may be any target such as a toilet space 2. The sanitary work in the present application is not limited to the sanitary work (cleaning or the like) performed on the sanitary work target, and includes checking whether the sanitary work target is in a normal state, and replenishing hygiene products such as toilet paper to be disposed in the sanitary work target. In addition, the sanitary work target in the present application is a target for which a cleaner is engaged in an operation related to sanitary work such as cleaning, checking, and replenishing of hygiene products in the sanitary work target for a certain period of time, and use of the sanitary work target by a user is restricted during the sanitary work operation. A cleaner may be interpreted as a worker, sanitary work by a cleaner may be interpreted as an operation by a cleaner, and a sanitary work target may be interpreted as an operation target.

As illustrated in FIG. 1, a processing target related to the control by the lavatory control system 1 may include the toilet space 2₁, a toilet space 2₂, and the like. Note that, when describing the toilet spaces such as the toilet space 2₁ and the toilet space 2₂ without distinguishing them, they may be described as the “toilet spaces 2”. For example, the toilet space 21 and the toilet space 2₂ may be the toilet spaces 2 disposed on different floors of the same facility such as a building. Although two toilet spaces 2, namely, the toilet space 2₁ and the toilet space 2₂ are illustrated in FIG. 1, the number of toilet spaces 2 may be three or more. When the lavatory control system 1 takes one toilet space 2 as a processing target, the toilet space 2 may be only the toilet space 2₁, for example.

The toilet space 2₁ illustrated in FIG. 1 includes toilet rooms TB1 to TB5, which are toilet rooms (also simply referred to as “rooms”) constituting private room spaces, and a common space CS1, which is a shared space other than the rooms. When the toilet rooms provided in the toilet space 2, such as the toilet room TB1, the toilet room TB2, the toilet room TB3, the toilet room TB4, and the toilet room TB5, are described without being distinguished from each other, they may be described as the “toilet rooms TB”.

In FIG. 1, a case in which the toilet space 2 includes five toilet rooms TB is described as an example. However, the toilet space 2 may include four or less toilet rooms TB or six or more toilet rooms TB. That is, the toilet space 2₁ illustrated in FIG. 1 is merely an example of the toilet space 2, and any configuration can be adopted for the toilet space 2. For example, when the lavatory control system 1 executes processing for a plurality of toilet spaces 2, the plurality of toilet spaces 2 may include the toilet space 2 having one toilet room TB. For example, the toilet space 2 having one toilet room TB may be a space in which the toilet space 2 itself is the toilet room TB, that is, a so-called barrier-free toilet.

The toilet room TB is a space (private room space) divided by partitions. Each toilet room TB includes a toilet bowl device 10 and functions as a place where a person performs excretion. Further, each toilet room TB includes an openable and closable door (not illustrated) for entering the toilet room TB. The door of each toilet room TB is similar to a door provided in a general toilet room TB, and thus detailed description thereof will be omitted. The toilet room TB need not be a space completely divided by the partitions, and in an upper part, a lower part, or the like of the partition, there may be provided a portion that is not separated from an adjacent toilet room TB, the common space, or the like.

When a common space provided in the toilet space 2, such as the common space CS1, is described without being distinguished, the common space may be referred to as a “common space CS”. The common space CS is a shared portion where a plurality of people can stay at the same time in the toilet space 2. For example, the common space CS has an entrance to the toilet space 2, a washing facility such as a washstand 50, and a path to each toilet room TB. The common space CS functions as a place enabling entry to the toilet space 2, washing of hands and the like, movement to each toilet room TB, and the like. When the toilet space 2 functions as the toilet space 2 for men, a urinal may be disposed in the common space CS. That is, the common space CS may also function as a place where a person performs excretion.

As described above, the toilet space 2 is provided in a space of a facility or the like and is a space that a user who uses the toilet enters and leaves. For example, the toilet space 2 includes the toilet rooms TB, the common space CS, and the like, and is a space in which structures related to a toilet are disposed. For example, the toilet space 2₁ illustrated in FIG. 1 includes the toilet rooms TB1 to TB5, in which a plurality of toilet bowl devices 10₁₁, 10₁₂, 10₁₃, 10₁₄, and 10₁₅ are respectively disposed, and the common space CS1, in which the washstand 50 is disposed. In this manner, the toilet space 2₁ includes a plurality of toilet rooms TB, in which the toilet bowl devices 10 are installed.

Next, the disposition of the devices in the toilet space 2 will be described with reference to the toilet space 2 illustrated in FIG. 1. The toilet bowl device 10₁₁ is disposed in the toilet room TB1. The toilet bowl device 10₁₂ is disposed in the toilet room TB2. The toilet bowl device 10₁₃ is disposed in the toilet room TB3. The toilet bowl device 10₁₄ is disposed in the toilet room TB4. The toilet bowl device 10₁₅ is disposed in the toilet room TB5. When the toilet bowl device 10₁₁, the toilet bowl device 10₁₂, the toilet bowl device 10₁₃, the toilet bowl device 10₁₄, the toilet bowl device 10₁₅, and the like are described without being distinguished from each other, they may be described as the “toilet bowl devices 10”.

Although FIG. 1 illustrates a case where the number of toilet bowl devices 10 is five as an example, any number of toilet bowl devices 10 can be adopted, and the number of toilet bowl devices 10 may be four or less or six or more. Details of the function and the like of the toilet bowl device 10 will be described below. The description of the toilet bowl device 10 as a sanitary work target may be interpreted as the description of the toilet room TB, in which the toilet bowl device 10 is disposed. The description of the toilet room TB as a sanitary work target may be interpreted as the description of the toilet bowl device 10 disposed in the toilet room TB. For example, the toilet bowl device 10₁₁ may be interpreted as the toilet room TB1, and the toilet room TB1 may be interpreted as the toilet bowl device 10₁₁.

The washstand 50 is disposed in the common space CS provided in the toilet space 2. The washstand 50 is a usage target of the toilet including a washbowl used when a toilet user washes their hands, washes their face, or looks in the mirror. In FIG. 1, the washstand 50 of the toilet space 2₁ is disposed in the common space CS1.

### 1-2. Arrangement of Toilet Space

An example of the arrangement of the toilet space 2 will be briefly described. The toilet space 2 may be provided in a space at any place as long as the toilet space 2 can be physically arranged therein. That is, any place can be adopted as the place where the toilet space 2 is provided. For example, the toilet space 2 may be provided in a commercial facility such as a department store. The place where the toilet space 2 is provided is not limited to a commercial facility such as a store, and may be any of various facilities. For example, the place where the toilet space 2 is provided may be an amusement park, a stadium, an office building, or the like. For example, the place where the toilet space 2 is provided may be a toilet provided in a region such as a tourist site. For example, the place where the toilet space 2 is provided may be a park, a parking lot, or the like. That is, the toilet may be provided outdoors such as in a park or a parking lot. As discussed above, the place where the toilet space 2 is provided may be any place as long as there is a space in which the toilet space 2 can be arranged therein.

1-3. Configuration Example of Toilet Room

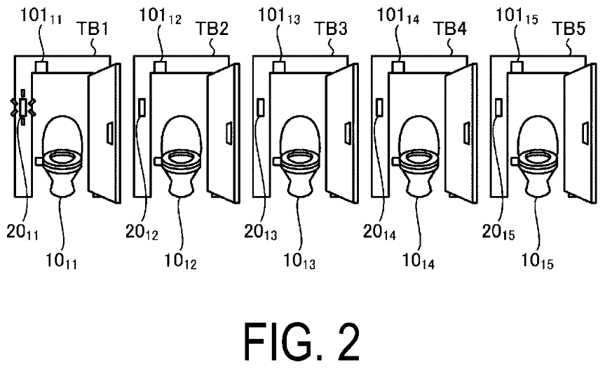

Next, a configuration example of the toilet room TB to be processed by the lavatory control system 1 (see FIG. 3) will be described with reference to FIG. 2. FIG. 2 is a diagram illustrating a configuration example of a toilet room according to the embodiment. Specifically, FIG. 2 is a front view illustrating a state in which the doors of the five toilet rooms TB in the toilet space 2₁ illustrated in FIG. 1 are open, as viewed from the door (entrance) side.

As illustrated in FIG. 2, the toilet bowl device 10₁₁ is disposed in the toilet room TB1, and a display 20₁₁ and a detection unit 101₁₁ are disposed near the entrance of the toilet room TB1. The toilet bowl device 10₁₂ is disposed in the toilet room TB2, and a display 20₁₂ and a detection unit 101₁₂ are disposed near the entrance of the toilet room TB2. The toilet bowl device 10₁₃ is disposed in the toilet room TB3, and a display 20₁₃ and a detection unit 101₁₃ are disposed near the entrance of the toilet room TB3. The toilet bowl device 10₁₄ is disposed in the toilet room TB4, and a display 20₁₄ and a detection unit 101₁₄ are disposed near the entrance of the toilet room TB4. The toilet bowl device 10₁₅ is disposed in the toilet room TB5, and a display 20₁₅ and a detection unit 101₁₅ are disposed near the entrance of the toilet room TB5.

Hereinafter, when the display 20₁₁, the display 20₁₂, the display 20₁₃, the display 20₁₄, the display 20₁₅, and the like are described without being distinguished from each other, they may be referred to as the “displays 20”. In FIG. 2, the displays 20 are installed for corresponding ones of the plurality of toilet rooms TB. Although a lamp that illuminates in a desired color is illustrated as an example of the display 20 in FIG. 2, the display 20 may be a device that can display information in any form, such as a device having a screen where text information or the like is displayed.

The disposition of the display 20 illustrated in FIG. 2 is merely an example, and the display 20 may be disposed in any manner as long as desired information can be presented to the user of the toilet. For example, the display 20 is not limited to being disposed in the toilet space 2, and may be disposed at any place. For example, the display 20 may be disposed at the entrance of the toilet space 2. In this case, a display apparatus such as a digital signage unit (a screen installed in front of the toilet space 2) may function as the display 20 configured to display information corresponding to the plurality of toilet rooms TB. In this case, the display 20 may display a plan view or the like of the corresponding toilet space 2, and, in a region corresponding to each toilet room TB in the plan view, may display information (recommendation information, non-recommendation information, or the like to be described below) of the toilet room TB in a superimposing manner.

When a plurality of toilet spaces 2 provided in a facility are sanitary work targets, one display 20 such as a digital signage unit may be disposed at a predetermined place at the entrance or on each floor of the facility. In this case, the display apparatus such as a digital signage unit may function as the display 20 configured to display information corresponding to the plurality of toilet spaces 2. In this case, the display 20 may display a floor map or the like of the corresponding facility, and may display information (recommendation information, non-recommendation information, or the like to be described below) of the toilet space 2 in a region corresponding to each toilet space 2 in the floor map in a superimposing manner.

The display 20 is not limited to a device disposed in the toilet space 2 or a facility, and may be a portable device such as a smartphone used by a user of the toilet. In this case, the lavatory control system 1 may transmit information to be displayed on the display 20 such as a smartphone used by the user of the toilet, and the display 20 used by the user of the toilet may display the received information. For example, the display 20 used by the toilet user displays the information received from the lavatory control system 1 by a display application or the like.

Further, in a case where the detection unit 101₁₁, the detection unit 101₁₂, the detection unit 101₁₃, the detection unit 101₁₄, the sensing unit 101₁₅, and the like are described without being distinguished from each other, they may be described as the “detection units 101”. The disposition of the detection units 101 illustrated in FIG. 2 is merely an example, and the detection units 101 may be disposed in any manner as long as desired information can be detected.

The detection unit 101 performs detection related to the toilet room TB. The detection unit 101 is a sensor (sensing unit) that detects use of the toilet room TB. The detection unit 101 detects information indicating the use of the toilet room TB. The detection unit 101 performs detection related to the toilet room TB, in which the toilet bowl device 10 is disposed. The detection unit 101 functions as a detection unit that detects a person (user) entering and leaving the toilet room TB, in which the toilet bowl device 10 is disposed. The detection unit 101 may be implemented by various sensors.

For example, the detection unit 101 may be various sensors such as a human body detection sensor, a behavior detection sensor, and a seat contact detection sensor. The detection unit 101 may be a door sensor that is provided on a door or the like of the toilet room TB and detects opening and closing of the door of the toilet room TB. The detection unit 101 may be an image sensor that captures an image of the vicinity of the door of the toilet room TB. The detection unit 101 may be a seating sensor that detects whether a user is sitting on the toilet bowl device 10. The detection unit 101 may be a sensor that detects whether toilet bowl flushing is being performed or whether a toilet remote control is being operated.

Note that the above are examples, and the detection unit 101 may be implemented by any means as long as the means can detect information that can be used to foresee the user entering and leaving the toilet bowl device 10. The toilet bowl device 10 and the detection unit 101 may be integrated. In this case, the toilet bowl device 10 having the detection unit 101 may be included in the lavatory control system 1. The detection unit 101 is not limited to being disposed on the outer wall surface of the toilet room TB illustrated in FIG. 2 as long as the use of the toilet bowl device 10 can be detected, and may be installed on the ceiling, the inner wall surface, the floor, or the like of the toilet room TB, or may be mounted on the toilet seat of the toilet bowl device 10.

The detection unit 101 includes, for example, a communicator (for example, a communication circuit or the like) having a wireless communication function, and is communicably connected to a control device 100 wirelessly. For example, when the detection unit 101 detects a person entering and leaving the toilet room TB, in which the toilet bowl device 10 is disposed, the detection unit 101 transmits detection information indicating the detection, the date and time of the detection, and the like to the control device 100 together with identification information (ID or the like) for identifying the toilet room TB or the toilet bowl device 10 disposed in the toilet room TB. For example, the detection unit 101 may transmit, to the control device 100, detection information indicating a period of time (use time) from when a person entered the toilet room TB, in which the toilet bowl device 10 is disposed, to when the above person has left the toilet room TB together with the identification information (ID or the like) for identifying the toilet room TB or the toilet room TB, in which the toilet bowl device 10 disposed in the toilet room TB is disposed. A specific example of processing for the above-described toilet room TB will be described below.

### 1-4. Configuration of Lavatory Control System

Next, a configuration of the lavatory control system 1 will be described with reference to FIG. 3. FIG. 3 is a diagram illustrating a configuration example of the lavatory control system according to the embodiment. Specifically, FIG. 3 illustrates the configuration of the lavatory control system 1.

The lavatory control system 1 includes the control device 100, which is an information processing apparatus (computer) that acquires information input to an input device 30 configured to receive input related to sanitary work progress and performs control related to the sanitary work progress. The lavatory control system 1 illustrated in FIG. 3 includes a plurality of the toilet bowl devices 10₁₁, 10₁₂, 10₁₃, 10₁₄, and 10₁₅, a plurality of the displays 20₁₁, 20₁₂, 20₁₃, 20₁₄, and 20₁₅, a plurality of the detection units 101₁₁, 101₁₂, 101₁₃, 101₁₄, and 101₁₅, the input device 30, and the control device 100.

The lavatory control system 1 may include a detection unit (common facility detection unit) taking, as detection targets, common facilities such as the washstand 50 and the like. The lavatory control system 1 may include a plurality of the control devices 100, a plurality of the input devices 30, and the like.

The toilet bowl device 10 is a usage target of a toilet that is used when a user using the toilet discharges feces, urine, or the like. The toilet bowl device 10 is disposed in the toilet room TB provided in the toilet space 2. For example, the toilet bowl device 10 includes a toilet seat device including a toilet seat on which a user sits and an operation unit for operating a nozzle for discharging water for washing. The toilet bowl device 10 has various types of configurations for enabling functions as a toilet such as a toilet lid and a toilet bowl in addition to the toilet seat device, but detailed description thereof will be omitted. The display 20 displays information regarding recommendation and non-recommendation of use of the toilet room TB. The detection unit 101 detects the use of the toilet room TB.

The input device 30 is an information processing apparatus (computer) to which a toilet cleaner can input information. For example, the input device 30 functions as an input terminal to which the cleaner in charge of performing sanitary work on the toilet space 2, the toilet room TB, and the like can input information. For example, the input device 30 is a portable device such as a smartphone carried by the cleaner. The input device 30 displays information for receiving input of information regarding sanitary work performed by the cleaner. The input device 30 displays contents for receiving input of information regarding sanitary work performed by the cleaner. The input device 30 is not limited to a portable device carried by the cleaner, and may be any device. For example, the input device 30 may be a device (an operation panel or the like) disposed in the toilet space 2, or may be a remote-control device disposed in each toilet room TB.

The input device 30 receives input of information regarding sanitary work performed by the cleaner. For example, the input device 30 receives input of information regarding sanitary work via the displayed contents regarding the sanitary work. For example, the input device 30 receives input of the information of the start, completion, and the like of the sanitary work by the cleaner. The start of the sanitary work referred to here is not limited to the actual start of the sanitary work, and includes a situation in which the sanitary work is scheduled to be started after the above input of the information. For example, the input device 30 receives input of the information of the start, completion, and the like of the sanitary work performed on the sanitary work target by the cleaner. For example, the input device 30 receives input of a reservation for sanitary work to be performed on a sanitary work target by the cleaner. The input device 30 transmits the information input by the cleaner (input information) to the control device 100. Note that the reservation for sanitary work to be performed on the sanitary work target is not limited to manual input by the cleaner or the like, and any form can be adopted as long as the desired reservation can be made. For example, the reservation for sanitary work to be performed on the sanitary work target may be a periodic automatic reservation. In this case, the reservation for sanitary work of the sanitary work target may be automatically set for 9:00 every Tuesday through the calendar function. For example, any device included in the lavatory control system 1, such as the control device 100, may manage information (reservation management information) regarding the reservation, and may perform periodic automatic reservation using the reservation management information.

The control device 100 is an information processing apparatus (computer) configured to execute control processing of controlling display of information regarding usage recommendation to a user with regard to a sanitary work target. For example, the control device 100 may be a cloud server or the like. The control device 100 is communicably connected to the display 20, the input device 30, the detection unit 101, and the like via a predetermined network N wirelessly or by wire. The control device 100 may be connected to the display 20, the input device 30, the detection unit 101, and the like in any manner as long as information can be transmitted and received, and may be communicably connected wirelessly or may be communicably connected by wire.

The control device 100 acquires various types of information. The control device 100 acquires information from other devices. The control device 100 executes control processing of controlling display of information indicating whether the sanitary work target is recommended for use by a user, using the information input by the cleaner. The control device 100 controls display of information indicating whether the sanitary work target is recommended for use by a user, using the information acquired from the input device 30.

The control device 100 executes control processing of judging whether the sanitary work target is used by a user, using the detection information that is the information received from the detection unit 101. The control device 100 judges whether a user has entered the toilet room TB, using the detection information. The control device 100 judges whether the toilet room TB is in use by a user, using the detection information. For example, the control device 100 may be a gateway apparatus or the like. The control device 100 acquires detection information such as sensor data detected for each sanitary work target (usage target).

The control device 100 may be disposed outside the toilet space 2 or may be disposed inside the toilet space 2. For example, the control device 100 may be a server apparatus disposed in a facility or the like in which the toilet space 2 is provided. The above description is merely an example, and the lavatory control system 1 may employ any device configuration and any arrangement.

For example, in the lavatory control system 1, in a case where the input terminal for the information is to be performed by the administrator of the lavatory control system 1, the administrator of the lavatory control system 1 may have the input device 30. In this case, the input device 30 may receive information indicating a sanitary work status input by the cleaner to a predetermined device (e.g., a portable device, a remote-control device in the toilet room TB, or the like), and may accept information input by the administrator based on the received information.

### 1-5. Functional Configuration of Control Device

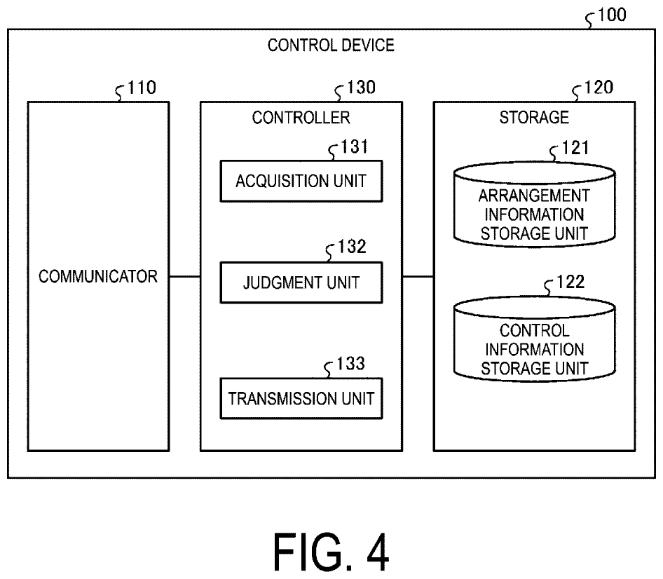

Hereinafter, a functional configuration of the control device will be described with reference to FIG. 4. FIG. 4 is a block diagram illustrating a configuration example of the control device according to the embodiment.

As illustrated in FIG. 4, the control device 100 includes a communicator 110, a storage 120, and a controller 130. The control device 100 may include an input terminal (e.g., a keyboard, a mouse, or the like) that receives various types of operations from the administrator or the like of the control device 100, and a display (e.g., a liquid crystal display or the like) for displaying various types of information.

The communicator 110 is realized by, for example, a communication circuit or the like. The communicator 110 is connected to the predetermined network N (see FIG. 3) in a wired or wireless manner, and transmits and receives information to and from an external information processing apparatus. For example, the communicator 110 is connected to the predetermined network N (see FIG. 3) in a wired or wireless manner, and transmits and receives information to and from other devices such as the display 20, the input device 30, and the detection unit 101.

The storage 120 is implemented by, for example, a semiconductor memory element such as a random access memory (RAM) or a flash memory, or a storage device such as a hard disk or an optical disk. For example, the storage 120 is a computer-readable recording medium that non-temporarily records data and the like used by an information processing program or the like for control processing and the like.

As illustrated in FIG. 4, the storage 120 according to the embodiment includes an arrangement information storage unit 121 and a control information storage unit 122. The storage 120 is not limited to any of the arrangement information storage unit 121 and the control information storage unit 122, and may store various information necessary for processing.

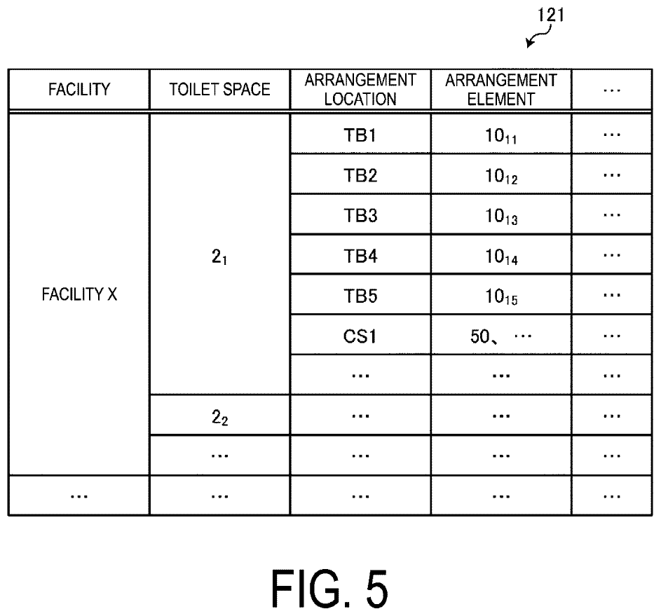

The arrangement information storage unit according to the embodiment stores various types of information regarding the arrangement of various types of usage targets as detection targets of the lavatory control system 1. For example, the arrangement information storage unit stores information regarding the arrangement of the toilet space 2, the toilet room TB, the toilet bowl device 10, and the washstand 50. FIG. 5 is a diagram illustrating an example of the arrangement information storage unit according to the embodiment. The arrangement information storage unit illustrated in FIG. 5 includes items such as “facility”, “toilet space”, “arrangement location”, and “arrangement element”.

The item “facility” indicates a place where a toilet space (toilet chamber) is arranged. Not only a structure but also various places can be registered as “facility” as long as the toilet space can be arranged therein. The item “toilet space” indicates identification information for identifying each toilet space. In FIG. 5, for the sake of description, reference signs such as “21” and “22” assigned to the respective toilet spaces are depicted in “toilet space”, and information (for example, a toilet space ID or the like) able to specify the toilet space is stored in “toilet space”.

The item “arrangement location” indicates identification information for identifying each arrangement location. In FIG. 5, for the sake of description, reference signs such as “TB1”, “TB2”, “TB3”, “TB4”, “TB5”, and “CS1” assigned to the respective configurations of the toilet space 2 are depicted in “arrangement location”, and information (for example, an arrangement location ID or the like) able to specify the arrangement location is stored in “arrangement location”.

The item “arrangement element” indicates identification information for identifying a usage target of a toilet arranged at the corresponding arrangement location. For example, “arrangement element” indicates identification information for identifying a usage target of a toilet, such as the toilet bowl device 10 and the washstand 50, arranged at the corresponding arrangement location. In FIG. 5, for the sake of description, reference signs such as “1011”, “1012”, “1013”, “1014”, “1015”, and “50” assigned to the respective configurations are depicted in “arrangement element”, and any information may be registered in “arrangement element” as long as each usage target can be identified.

For example, “arrangement element” stores information able to specify a toilet bowl device (for example, a toilet bowl device ID or the like), identification information for identifying a urinal (for example, a urinal ID or the like), or identification information for identifying a washbowl (for example, a washbowl ID or the like) arranged at the corresponding arrangement location.

The example in FIG. 5 indicates that the toilet space 2₁ identified by “21” includes, as arrangement locations, the toilet room TB1 identified by “TB1”, the toilet room TB2 identified by “TB2”, the toilet room TB3 identified by “TB3”, the toilet room TB4 identified by “TB4”, and the toilet room TB5 identified by “TB5”. Furthermore, it is indicated that the toilet space 2₁ includes the common space CS1 identified by “CS1” as an arrangement location.

It is indicated that the toilet bowl device 10₁₁ identified by “10₁₁” is arranged in the toilet room TB1, which is the arrangement location identified by “TB1”. It is indicated that the toilet bowl device 10₁₂ identified by “10₁₂” is arranged in the toilet room TB2, which is the arrangement location identified by “TB2”. It is indicated that the toilet bowl device 10₁₃ identified by “10₁₃” is arranged in the toilet room TB3, which is the arrangement location identified by “TB3”. It is indicated that the toilet bowl device 10₁₄ identified by “10₁₄” is arranged in the toilet room TB4, which is the arrangement location identified by “TB4”. It is indicated that the toilet bowl device 10₁₅ identified by “10₁₅” is arranged in the toilet room TB5, which is the arrangement location identified by “TB5”.

The arrangement information storage unit 121 is not limited to storing the above-discussed information, and may store various information in accordance with the purpose. For example, the arrangement information storage unit 121 may store information (for example, a sensor ID or the like) capable of specifying a sensor (detection unit) that detects sensor data (detection information) of each usage target to be detected in association with the usage target detected by the sensor.

Information indicating a specific arrangement position of the usage target of each toilet (for example, latitude and longitude information or the like) may be stored in association with the usage target of each toilet. For example, information indicating a specific arrangement position of each toilet space 2 (for example, latitude and longitude information or the like) may be stored in association with each toilet space 2. For example, information indicating a specific arrangement position of each toilet bowl device 10 (for example, latitude and longitude information or the like) may be stored in association with each toilet bowl device 10. For example, the arrangement information storage unit 121 may store information detected by the washstand 50 and information indicating a specific arrangement position of the washstand 50 (for example, latitude and longitude information) in association with the washstand 50.

The control information storage unit 122 stores various information used in the control processing. For example, the control information storage unit 122 stores information used for controlling display of information. For example, the control information storage unit 122 stores information related to thresholds (for example, a threshold THI and the like) used in the judgment processing of a display time count. For example, the control information storage unit 122 stores information indicating a queue for performing sanitary work on a plurality of the sanitary work targets (sanitary work queue information).

The above description is merely an example, and the control information storage unit 122 stores various acquired information.

Referring back to FIG. 4, the description will be continued. The controller 130 is implemented by, for example, a central processing unit (CPU), a graphics processing unit (GPU), or the like executing a program (for example, an information processing program of the control processing according to the present disclosure) stored inside the control device 100 while using a RAM or the like as a work area. The controller 130 can also be implemented by an integrated circuit such as an application specific integrated circuit (ASIC) or a field programmable gate array (FPGA).

As illustrated in FIG. 4, the controller 130 includes an acquisition unit 131, a judgment unit 132, and a transmission unit 133, and enables or executes functions and operations of information processing described below. The internal configuration of the controller 130 is not limited to the configuration illustrated in FIG. 4, and may have another configuration as long as the configuration performs information processing to be described below.

The acquisition unit 131 acquires various types of information. The acquisition unit 131 acquires various types of information from the storage 120. The acquisition unit 131 receives information from other devices. The acquisition unit 131 receives information from the displays 20, the input device 30, the detection units 101, and the like.

The acquisition unit 131 receives, from the input device 30, information (input information) input to the input device 30. The acquisition unit 131 receives, from the input device 30, input information input by a toilet cleaner. The acquisition unit 131 receives, from the input device 30, input information input to the input device 30 and indicating the start, completion, and the like of the sanitary work operation. For example, the acquisition unit 131 receives, from the input device 30, input information input to the input device 30 and indicating the start and completion of the sanitary work operation for each sanitary work target. For example, the acquisition unit 131 receives, from the input device 30, input information input to the input device 30 and indicating a reservation of the sanitary work operation for each sanitary work target.

The acquisition unit 131 receives, from the detection unit 101, information (detection information or the like) detected by the detection unit 101. The acquisition unit 131 receives detection information detected with regard to the sanitary work target (usage target) of the toilet from the detection unit 101. The acquisition unit 131 receives detection information detected by a sensor or the like corresponding to the usage target of the toilet from the detection unit 101.

The acquisition unit 131 receives, from the detection unit 101, detection information detected by the detection unit 101 with regard to the toilet room TB. The acquisition unit 131 receives, from the detection unit 101, detection information detected by the detection unit 101 with regard to the toilet room TB, in which the toilet bowl device 10 is disposed. The acquisition unit 131 receives, from the common facility detection unit, detection information detected by the common facility detection unit for each facility such as the washstand 50.

The acquisition unit 131 acquires information to be used in the processing from the storage 120. The acquisition unit 131 acquires information to be used in the control processing from the control information storage unit 122. The acquisition unit 131 acquires information corresponding to the toilet room TB to become a judgment target from the control information storage unit 122.

The judgment unit 132 executes control processing related to display control. When sanitary work completion information of the toilet room TB is input to the input device 30, the judgment unit 132 performs control to cause the display 20 to display usage recommendation information that recommends use of the target toilet room TB, the sanitary work completion information of which has been input. The judgment unit 132 performs control to cause the display 20 corresponding to the target toilet room TB among the plurality of displays 20 to display usage recommendation information.

The judgment unit 132 performs control to cancel the display of the usage recommendation information by the display 20 upon an elapse of a predetermined time from the start of the display. The judgment unit 132 performs control to cancel the display of the usage recommendation information by all the displays 20 displaying the usage recommendation information after the completion of sanitary work of the plurality of toilet rooms TB. When the toilet room TB, for which the usage recommendation information is being displayed, becomes in use, the judgment unit 132 performs control to cancel the display of the usage recommendation information of the toilet room TB by the display 20. When the use of the toilet room TB, for which the display of the usage recommendation information has been canceled, has ended, the judgment unit 132 performs control to display again the usage recommendation information that recommends the use of the toilet room TB.

When sanitary work start information of the toilet room TB is input to the input device 30, the judgment unit 132 performs control to cause the display 20 to display usage non-recommendation information indicating that the use of the designated toilet room TB, which is the toilet room TB designated by the sanitary work start information, is not recommended. When sanitary work completion information of the designated toilet room TB is input to the input device 30, the judgment unit 132 performs control to cancel the display of the usage non-recommendation information of the designated toilet room TB by the display 20.

Based on the queue for performing the sanitary work on the plurality of toilet rooms TB, when sanitary work completion information of one toilet room TB is input to the input device 30, the judgment unit 132 performs control to cause the display 20 to display usage non-recommendation information indicating that a designated toilet room TB, which is another toilet room TB subsequent in the queue to the one toilet room TB, is not recommended for use. The judgment unit 132 performs control to cause the display 20 corresponding to the designated toilet room TB among the plurality of displays 20 to display usage non-recommendation information.

When the toilet room TB with usage non-recommendation information being displayed becomes in use, the judgment unit 132 performs control to cause the display 20 to display usage non-recommendation information indicating that the use of another toilet room TB, which is different from the toilet room TB, is not recommended. The judgment unit 132 performs control to cause the display 20 to display usage non-recommendation information indicating that the use of the toilet room TB designated by an instruction of the administrator is not recommended.

When the toilet room TB, for which usage non-recommendation information is being displayed, becomes in use, the judgment unit 132 performs control to cancel the display of the usage non-recommendation information of the toilet room TB by the display 20. When the use of the toilet room TB, for which the display of the usage non-recommendation information has been canceled, has ended, the judgment unit 132 performs control to display again the usage non-recommendation information that recommends the use of the toilet room TB.

The judgment unit 132 performs judgment processing. The judgment unit 132 performs the judgment processing using various types of information stored in the storage 120. The judgment unit 132 performs the judgment processing using various types of information acquired by the acquisition unit 131. The judgment unit 132 performs the judgment processing using various types of values (information) calculated. The judgment unit 132 performs the judgment processing using the thresholds stored in the control information storage unit 122.

The judgment unit 132 generates various types of information used for judgment. The judgment unit 132 performs generation processing. The judgment unit 132 performs the generation processing using various types of information stored in the storage 120. The judgment unit 132 performs the generation processing using various types of information acquired by the acquisition unit 131. The judgment unit 132 generates information indicating recommendation or non-recommendation of use of the sanitary work target to the user.

The judgment unit 132 generates control information for instructing the display 20 to be turned on and off. The judgment unit 132 generates control information including information for designating an illumination mode to the display 20. The judgment unit 132 generates control information including information for designating a color to be illuminated on the display 20.

When a condition for starting the display by the display 20 is satisfied, the judgment unit 132 decides to turn on the display of the display 20. The judgment unit 132 generates control information (illumination instruction information) for instructing the display 20 to be turned on, and instructs the transmission unit 133 to transmit the generated control information (illumination instruction information) to the display 20.

When a condition for starting the display of recommendation information by the display 20 is satisfied, the judgment unit 132 decides to turn on the display of the recommendation information by the display 20. The judgment unit 132 generates control information (first illumination instruction information) for instructing the display 20 to turn on the display of recommendation information, and instructs the transmission unit 133 to transmit the generated control information (first illumination instruction information) to the display 20.

When a condition for starting the display of non-recommendation information by the display 20 is satisfied, the judgment unit 132 decides to turn on the display of the non-recommendation information by the display 20. The judgment unit 132 generates control information (second illumination instruction information) for instructing the display 20 to turn on the display of non-recommendation information, and instructs the transmission unit 133 to transmit the generated control information (second illumination instruction information) to the display 20.

When a condition for ending the information display by the display 20 is satisfied, the judgment unit 132 decides to turn off the display by the display 20. The judgment unit 132 generates control information (turning-off instruction information) for instructing the display 20 to turn off, and instructs the transmission unit 133 to transmit the generated control information (turning-off instruction information) to the display 20.

The judgment unit 132 judges whether a predetermined time has elapsed since the start of illumination of the display 20. The judgment unit 132 counts the time from the start of illumination of the display 20, and judges whether the counted time has reached a threshold (for example, the threshold TH1). When the counted time has reached a threshold (for example, the threshold TH1), the judgment unit 132 decides to turn off the display by the display 20. The judgment unit 132 generates control information (turning-off instruction information) for instructing the display 20 to turn off, and instructs the transmission unit 133 to transmit the generated control information (turning-off instruction information) to the display 20.

The judgment unit 132 executes processing of generating contents regarding control of the lavatory control system 1. The judgment unit 132 generates contents to be provided to the display 20, the input device 30, and the like. For example, the judgment unit 132 generates contents for receiving input of information regarding sanitary work performed by the cleaner. For example, the judgment unit 132 generates contents by appropriately using various technologies such as Java (trade name). The judgment unit 132 may generate contents based on the format of CSS, JavaScript (trade name), or HTML. In addition, for example, the judgment unit 132 may generate contents in various forms such as JPEG (Joint Photographic Experts Group), GIF (Graphics Interchange Format), and PNG (Portable Network Graphics).

The transmission unit 133 executes transmission processing of transmitting various types of information. The transmission unit 133 executes the transmission processing by transmitting information to other devices. The transmission unit 133 executes control processing of controlling processing of other devices. The transmission unit 133 executes the control processing of controlling processing of other devices as transmission targets by transmitting various types of information to other devices.

The transmission unit 133 transmits information to be displayed, to the display 20, the input device 30, or the like. The transmission unit 133 transmits, to the display 20, control information for controlling the display of the display 20. The transmission unit 133 transmits, to the display 20, control information for instructing the display 20 to perform illumination. The transmission unit 133 transmits, to the display 20, control information for instructing the display 20 to turn off the after an elapse of a display period.

When the judgment unit 132 decides to cause the display 20 to perform illumination corresponding to recommendation information, the transmission unit 133 transmits control information (first illumination instruction information) for instructing the display 20 to illuminate the recommendation information on the display 20. When the judgment unit 132 decides to cause the display 20 to perform illumination corresponding to non-recommendation information, the transmission unit 133 transmits, to the display 20, control information (second illumination instruction information) for instructing illumination of the non-recommendation information on the display 20.

When the judgment unit 132 decides to cause the display 20 to turn off the display, the transmission unit 133 transmits control information (turning-off instruction information) for instructing the display 20 to turn off the display to the display 20.

The transmission unit 133 notifies the administrator of information indicating the toilet room TB, which needs sanitary work. The transmission unit 133 transmits, to a device (administrator's device) used by the administrator of the lavatory control system 1, information indicating the toilet room TB, which needs sanitary work. The transmission unit 133 transmits, to the administrator's device, which is a smartphone carried by the administrator of the lavatory control system 1, the information indicating the toilet room TB, which needs sanitary work.

### 1-6. Display Example

An example of display control processing in accordance with a sanitary work status will be described below. Hereinafter, display control of information recommending use of a usage target (also referred to as “usage recommendation information”) and display control of information not recommending use of a usage target (also referred to as “usage non-recommendation information”) will be described. The usage recommendation information and the usage non-recommendation information may be combined in an appropriate manner as long as they can be processed in combination.

As the usage recommendation information, any information can be adopted as long as the toilet use can be recommended to the user. For example, the usage recommendation information includes any information in accordance with a display mode of the display 20. For example, the usage recommendation information may be illumination in a mode (for example, color) indicating the usage recommendation. That is, the display of information by the display 20 includes illumination in a desired color. For example, in a case where the display 20 is a lamp, the usage recommendation information may be illumination of the lamp in blue. In this case, the usage recommendation information refers to a color of blue to be illuminated. In a case where the display 20 can display text information, the usage recommendation information may include text information such as “usage recommended”, “usable”, and “cleaned”. Note that the above description is merely an example. As the usage recommendation information, any information can be adopted as long as the usage recommendation can be conveyed to the user.

As the usage non-recommendation information, any information can be adopted as long as the usage non-recommendation can be conveyed to the user. For example, the usage non-recommendation information includes any information in accordance with the display mode of the display 20. For example, the usage non-recommendation information may be illumination in a mode (for example, color) indicating the usage non-recommendation. For example, in the case where the display 20 is a lamp, the usage non-recommendation information may be illumination of the lamp in red. In this case, the usage non-recommendation information refers to a color of red to be illuminated. In the case where the display 20 can display text information, the usage non-recommendation information may include text information such as “usage not recommended”, “unusable”, and “yet to be cleaned”. Note that the above description is merely an example. As the usage non-recommendation information, any information can be adopted as long as the usage non-recommendation can be conveyed to the user.

### 1-6-1. Display of Recommendation Information

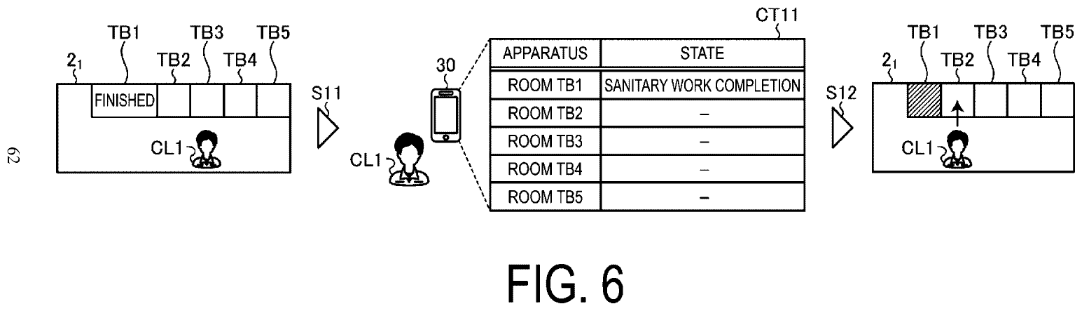

An overview of the recommendation information display performed by the lavatory control system 1 will be described. First, an overview of processing will be described with reference to FIG. 6. FIG. 6 is a diagram illustrating an overview of processing relating to the recommendation information display performed by the lavatory control system. In FIG. 6, a case where the five toilet rooms TB1 to TB5 of the toilet space 2₁ in FIG. 1 are sanitary work targets and a cleaner CL1 performs sanitary work on the sanitary work targets will be described as an example.

The toilet space 2₁ illustrated on the left side in FIG. 6 indicates a state in which the cleaner CL1 has completed sanitary work of the toilet room TB1. The cleaner CL1 inputs the sanitary work completion information of the toilet room TB1 to the input device 30 serving as an input terminal (step S11). The cleaner CL1, who has completed the sanitary work of the toilet room TB1 operates the input device 30, which is a smartphone carried by the cleaner CL1, to input the sanitary work completion information indicating that the sanitary work of the toilet room TB1 has been completed. In FIG. 6, the cleaner CL1 operates the input device 30, on which a content CT11 is displayed, and inputs the sanitary work completion information indicating that the sanitary work of the toilet room TB1 has been completed.

The content CT11 illustrated in FIG. 6 is displayed on the input device 30 used by the cleaner CL1. For example, the control device 100 generates the content CT11 and transmits the content CT11 to the input device 30 used by the cleaner CL1. The input device 30 used by the cleaner CL1 displays the content CT11 received from the control device 100.

As illustrated in FIG. 6, the content CT11 contains information of five toilet rooms TB including the toilet room TB1 (also denoted as the room TB1 in the drawing; the same applies hereinafter), the toilet room TB2 (also denoted as the room TB2 in the drawing; the same applies hereinafter), the toilet room TB3 (also denoted as the room TB3 in the drawing; the same applies hereinafter), the toilet room TB4 (also denoted as the room TB4 in the drawing; the same applies hereinafter), and the toilet room TB5 (also denoted as the room TB5 in the drawing; the same applies hereinafter), which are sanitary work targets. The content CT11 contains a list in which information indicating each of the toilet rooms TB1 to TB5 (for example, a room ID, a name of an apparatus disposed in the room, or the like) and information indicating a state related to the sanitary work progress are associated with each other.

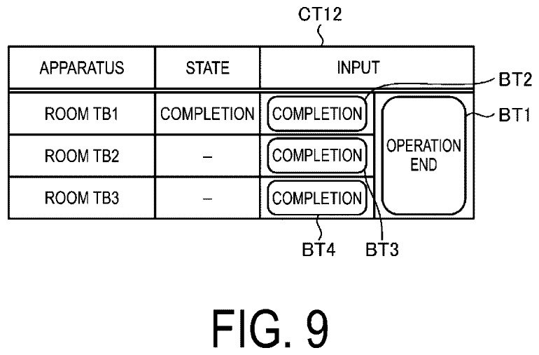

Note that the content CT11 illustrated in FIG. 6 is merely an example, and the content CT11 may include a button for receiving an input of sanitary work completion of each toilet room TB, for example, as in a content CT12 illustrated in FIG. 9. In this case, when the cleaner CL1 designates a button corresponding to the toilet room TB1 in the content CT11, the input device 30 receives an input of the sanitary work completion information indicating that the sanitary work of the toilet room TB1 has been completed. Then, the input device 30 transmits information indicating that the sanitary work of the toilet room TB1 has been completed (sanitary work completion information) to the control device 100. In this manner, the lavatory control system 1 acquires information indicating the sanitary work status of the sanitary work target such as the toilet room TB based on the input received by the input device 30.

Then, the input device 30 displays the content CT11, in which the state of the toilet room TB1 is changed to completion. The cleaner CL1 starts the sanitary work of the toilet room TB2, which is a subsequent sanitary work target. The input device 30 may receive an input of the sanitary work completion information indicating that the sanitary work of the toilet room TB1 has been completed, by a sound input or the like by the cleaner CL1. The display content of various types of contents such as the content CT11 may be changed by the control device 100 or the input device 30. In the case where the control device 100 changes the display content, the control device 100 updates the content CT11 based on the information received from the input device 30, and transmits the updated content CT11 to the input device 30.

The control device 100 having received the sanitary work completion information of the toilet room TB 1 from the input device 30 performs control to cause the display 20₁₁ to display usage recommendation information that recommends use of the toilet room TB1, the sanitary work completion information of which has been input (step S12). For example, the control device 100 controls the display 20₁₁ of the toilet room TB1 to be illuminated in a mode (recommendation mode) in a color (for example, blue or the like) indicating usage recommendation. Then, the display 20₁₁ of the toilet room TB1 is illuminated in the recommendation mode, and displays the usage recommendation information indicating that the use of the toilet room TB1 is recommended.

In FIG. 6, a region corresponding to the toilet room TB1 in the toilet space 2₁ illustrated on the right side is hatched to indicate a state in which the display 20₁₁ of the toilet room TB1 is illuminated in the recommendation mode (for example, blue). In a case where the display 20 can display an image or the like, a plan view corresponding to the state of the toilet space 2₁ illustrated on the right side in FIG. 6 (a diagram in which the region of the toilet room TB1 is colored in blue, or the like) may be displayed.

When sanitary work of a toilet is to be performed, the sanitary work of the toilet cannot be performed in a case where the toilet is being used. Therefore, as described above, by recommending the user to use a toilet room, the sanitary work of which has been completed, the lavatory control system 1 can reduce a possibility that a toilet room scheduled to be subjected to sanitary work is used, thereby making it possible to improve the efficiency of the sanitary work operation.

The flows of processing of various types of control will be described below based on each flowchart. Hereinafter, the lavatory control system 1 will be described as a main processing subject, but each of first processing to fourteenth processing may be performed by any device such as the control device 100, the display 20, the input device 30, or the sensing unit 101 in accordance with the device configuration included in the lavatory control system 1. Further, the first processing to the fourteenth processing described below may be executed in any combination as long as the respective processing operations can be combined.

### 1-6-2. First Control

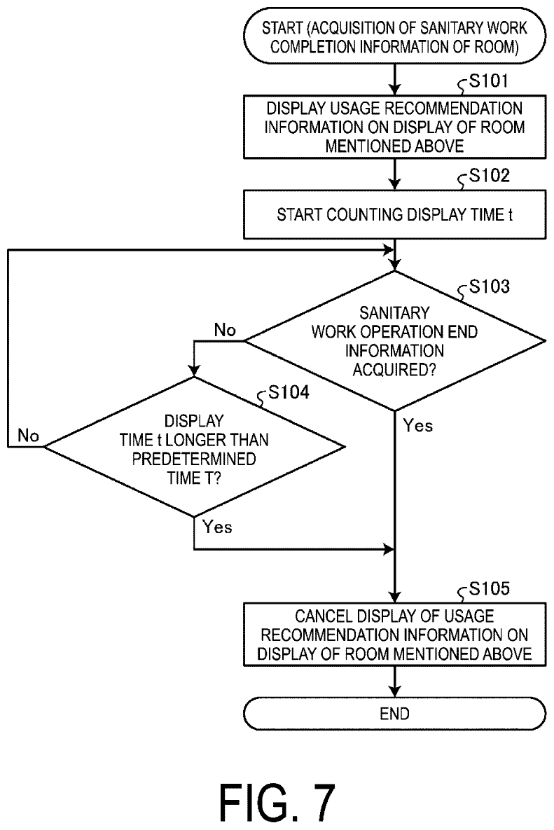

First control by the lavatory control system 1 will be described with reference to FIGS. 7 to 9. First, a processing flow of processing executed by the lavatory control system 1 will be described with reference to FIG. 7. FIG. 7 is a flowchart illustrating an example of a procedure for processing executed by the lavatory control system. Specifically, FIG. 7 is a flowchart illustrating an example of a procedure for the first processing executed by the lavatory control system 1.

First, in the first processing, the lavatory control system 1 acquires sanitary work completion information of a room. For example, the control device 100 receives sanitary work completion information of the toilet room TB1 from the input device 30.

The lavatory control system 1 displays usage recommendation information on the display of the room (step S101). For example, the control device 100 controls the display 20₁₁ of the toilet room TB1 to be illuminated in a mode (recommendation mode) in a color (for example, blue or the like) indicating usage recommendation.

The lavatory control system 1 starts counting a display time t (step S102). For example, the control device 100 starts counting the display time t from the start of illumination of the display 20₁₁ of the toilet room TB1.

The lavatory control system 1 judges whether sanitary work operation end information has been acquired (step S103). For example, the control device 100 judges whether the sanitary work operation end information has been received from the input device 30.

When the sanitary work operation end information has been acquired (step S103: Yes), the lavatory control system 1 executes processing of step S105. For example, when the sanitary work operation end information has been received from the input device 30, the control device 100 executes the processing of step S105.

When the sanitary work operation end information has not been acquired yet (step S103: No), the lavatory control system 1 judges whether the display time t is equal to or longer than a predetermined time T (step S104). For example, the control device 100 judges whether the display time t is equal to or longer than the predetermined time T (for example, the threshold TH1) when the sanitary work operation end information has not been received from the input device 30.

When the display time t is not equal to or longer than the predetermined time T (step S104: No), the lavatory control system 1 returns to step S103 and repeats the processing. For example, when it is judged that the display time t has not reached the predetermined time T, the control device 100 returns to step S103 and repeats the process.

When the display time t is equal to or longer than the predetermined time T (step S104: Yes), the lavatory control system 1 executes processing of step S105. For example, when it is judged that the display time t has reached the predetermined time T, the control device 100 executes the processing of step S105.

The lavatory control system 1 cancels the usage recommendation display on the display of the room (step S105). For example, the control device 100, upon receiving the sanitary work operation end information from the input device 30, performs control to cancel the illumination of the display 20₁₁ of the toilet room TB1 in the recommendation mode, that is, to turn off the display 20₁₁. For example, when the display time t has reached the predetermined time T before receiving the sanitary work operation end information from the input device 30, the control device 100 performs control to cancel the illumination of the display 20₁₁ of the toilet room TB1 in the recommendation mode.

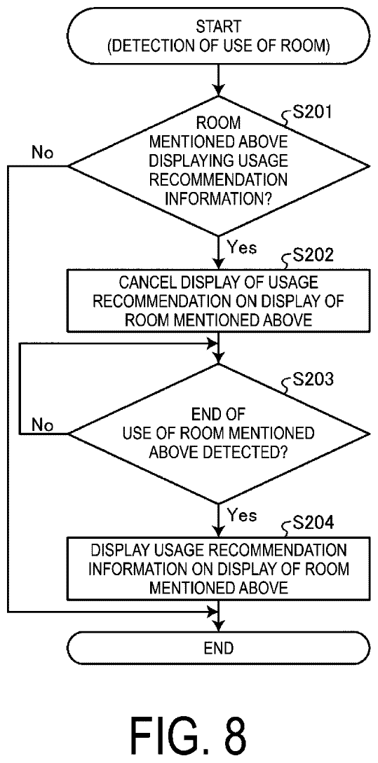

A processing flow of the second processing executed by the lavatory control system 1 will be described with reference to FIG. 8. FIG. 8 is a flowchart illustrating an example of a procedure for processing executed by the lavatory control system. Specifically, FIG. 8 is a flowchart illustrating an example of a procedure for the second processing executed by the lavatory control system 1.

First, in the second processing, the lavatory control system 1 detects use of a room. For example, the control device 100 receives detection information indicating the use of the toilet room TB1 from the detection unit 101₁₁ of the toilet room TB1.

The lavatory control system 1 judges whether the room is displaying usage recommendation information (step S201). For example, the control device 100 judges whether the display 20₁₁ of the toilet room TB1 is illuminated in a mode (recommendation mode) in a color (for example, blue or the like) indicating usage recommendation.

The lavatory control system 1 ends the second processing when the room is not displaying usage recommendation information (step S201: No). For example, when it is judged that the display 20₁₁ of the toilet room TB1 is not illuminated in the recommendation mode, the control device 100 ends the second processing.

When the room is displaying usage recommendation information (step S201: Yes), the lavatory control system 1 cancels the usage recommendation display on the display of the room (step S202). For example, when it is judged that the display 20₁₁ of the toilet room TB1 is illuminated in the recommendation mode, the control device 100 performs control of canceling the illumination of the display 20₁₁ of the toilet room TB1 in the recommendation mode.

The lavatory control system 1 judges whether the end of use of the room is detected (step S203). For example, the control device 100 judges whether the use of the toilet room TB1 has ended based on detection information received from the detection unit 101₁₁ of the toilet room TB1.

When the end of use of the room has not been detected (step S203: No), the lavatory control system 1 repeats the processing of step S203. For example, when it is judged that the use of the toilet room TB1 has not ended, the control device 100 repeats the processing of step S203.

When the end of use of the room is detected (step S203: Yes), the lavatory control system 1 displays usage recommendation information on the display of the room (step S204). For example, when it is judged that the use of the toilet room TB1 has ended, the control device 100 controls the display 20₁₁ of the toilet room TB1 to be illuminated in the recommendation mode.

Here, an example of a mode for receiving an input will be described with reference to FIG. 9. FIG. 9 is a diagram illustrating an example of a mode for receiving an input related to sanitary work progress. Specifically, FIG. 9 is a diagram illustrating an example of a first reception mode for receiving an input related to sanitary work progress. In FIG. 9, for the sake of simplification of illustration, a case where information of only three toilet rooms, namely the toilet room TB1, the toilet room TB2, and the toilet room TB3 is displayed is illustrated. For example, when the toilet space 2₁ in FIG. 1 is a target space, information of five toilet rooms TB, namely, the toilet rooms TB1 to TB5, is displayed.

The content CT12 illustrated in FIG. 9 is displayed on the input device 30. For example, the control device 100 generates the content CT12 and transmits the content CT12 to the input device 30. The input device 30 displays the content CT12 received from the control device 100.

As illustrated in FIG. 9, the content CT12 includes buttons BT1 to BT4 for receiving input. For example, the button BT1 is a button for receiving an input of information indicating the end of operation. In FIG. 9, when the button BT1 is designated, the input device 30 transmits, to the control device 100, information indicating the end of operation (sanitary work operation end information) of all the toilet rooms TB as sanitary work targets such as the toilet rooms TB1 to TB3.

Each of the buttons BT2 to BT4 is a button for receiving an input of information indicating the end of operation of each toilet room TB. In FIG. 9, the button BT2 corresponds to the toilet room TB1, the button BT3 corresponds to the toilet room TB2, and the button BT4 corresponds to the toilet room TB3.

FIG. 9 illustrates a case where the room TB1 is in a state of sanitary work completion. For example, when the sanitary work of the toilet room TB1 is completed, the cleaner who uses the input device 30 designates the button BT2 by touching (contacting) an area in which the button BT2 is displayed in the display screen of the input device 30 with a finger or the like. Then, the input device 30 transmits, to the control device 100, information indicating that the sanitary work of the toilet room TB1 has been completed (sanitary work completion information).

For example, when the button BT3 is designated, the input device 30 transmits, to the control device 100, information indicating that the sanitary work of the toilet room TB2 has been completed (sanitary work completion information). Then, the input device 30 displays the content CT12, in which the state of the toilet room TB2 is changed to completion. For example, when the button BT4 is designated, the input device 30 transmits, to the control device 100, information indicating that the sanitary work of the toilet room TB3 has been completed (sanitary work completion information). Then, the input device 30 displays the content CT12, in which the state of the toilet room TB3 is changed to completion.

### 1-6-3. Second Control

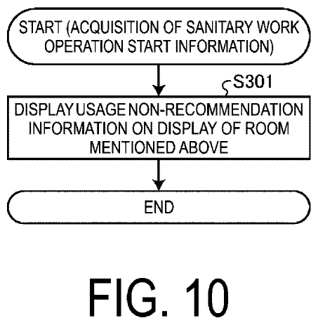

Next, second control by the lavatory control system 1 will be described with reference to FIGS. 10 to 12. Specifically, in the second control, a case will be described as an example in which a room scheduled to be subjected to sanitary work is set to be not recommended, and set to be recommended upon completion of the sanitary work. When processing of only the second control is executed, the lavatory control system 1 need not include the detection unit 101. When the processing of only the second control is executed, the lavatory control system 1 need not include the detection unit 101 provided in association with each toilet room TB in FIG. 2.

First, a processing flow of third processing executed by the lavatory control system 1 will be described with reference to FIG. 10. FIG. 10 is a flowchart illustrating an example of a procedure for processing executed by the lavatory control system. Specifically, FIG. 10 is a flowchart illustrating an example of a procedure for the third processing executed by the lavatory control system 1.

First, in the third processing, sanitary work operation start information is acquired. For example, the control device 100 receives, from the input device 30, sanitary work operation start information indicating the start of sanitary work operation of all the toilet rooms TB as sanitary work targets. For example, the control device 100 receives, from the input device 30, sanitary work operation start information indicating the start of sanitary work operation of the toilet room TB1.

The lavatory control system 1 displays usage non-recommendation information on the display of the room (step S301). Upon receiving the sanitary work operation start information indicating the start of sanitary work operation of all the toilet rooms TB, the control device 100 controls the displays 20 of all the toilet rooms TB as sanitary work targets to be illuminated in a mode (non-recommendation mode) in a color (for example, red or the like) indicating usage non-recommendation. Upon receiving the sanitary work operation start information indicating the start of sanitary work operation of all the toilet rooms TB1, the control device 100 controls the display 20₁₁ of the toilet room TB1 to be illuminated in the non-recommendation mode.

The input device 30 may individually transmit the sanitary work start information to each toilet room TB, or may collectively transmit the sanitary work start information to all the toilet rooms TB. In the case of collectively transmitting the information to all the toilet rooms TB, in the example in FIG. 1, the input device 30 may collectively transmit the sanitary work start information to the control device 100 with regard to five toilet rooms TB including the toilet rooms TB1 to TB5.

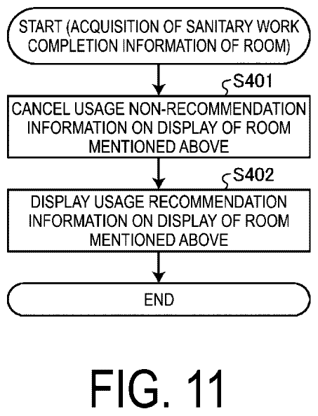

A processing flow of the fourth processing executed by the lavatory control system 1 will be described with reference to FIG. 11. FIG. 11 is a flowchart illustrating an example of a procedure for processing executed by the lavatory control system. Specifically, FIG. 11 is a flowchart illustrating an example of a procedure for the fourth processing executed by the lavatory control system 1.

First, in the fourth processing, sanitary work completion information of a room is acquired. For example, the control device 100 receives, from the input device 30, sanitary work completion information indicating the sanitary work completion of the toilet room TB1.

The lavatory control system 1 cancels the usage non-recommendation information on the display of the room (step S401). For example, when the display 20₁₁ of the toilet room TB1 is being illuminated in the non-recommendation mode, the control device 100 performs control to cancel the illumination of the display 20₁₁ of the toilet room TB1 in the non-recommendation mode.

The lavatory control system 1 displays usage recommendation information on the display of the room (step S402). For example, the control device 100 controls the display 20₁₁ of the toilet room TB 1 to be illuminated in the recommendation mode.

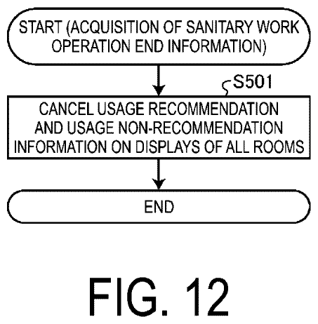

A processing flow of the fifth processing executed by the lavatory control system 1 will be described with reference to FIG. 12. FIG. 12 is a flowchart illustrating an example of a procedure for processing executed by the lavatory control system. Specifically, FIG. 12 is a flowchart illustrating an example of a procedure of the fifth processing executed by the lavatory control system 1.

First, in the fifth processing, sanitary work operation end information is acquired. For example, the control device 100 receives, from the input device 30, sanitary work operation end information indicating the end of the sanitary work operation of all the toilet rooms TB as sanitary work targets.

The lavatory control system 1 cancels the usage recommendation and usage non-recommendation information on the displays of all the rooms (step S501). For example, the control device 100 performs control of canceling the illumination of the displays 20 of all the toilet rooms TB, with respect to the displays 20 being illuminated in the recommendation mode or non-recommendation mode.

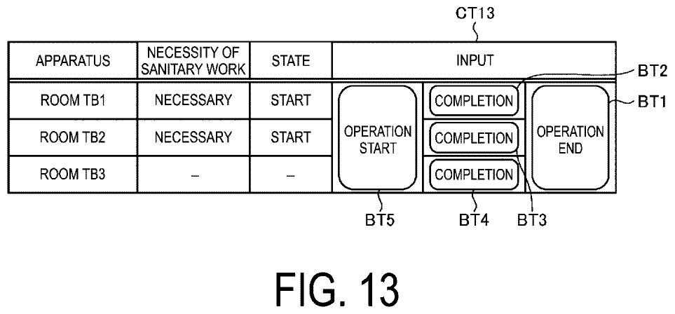

Here, an example of a mode for receiving an input will be described with reference to FIG. 13. FIG. 13 is a diagram illustrating an example of a mode for receiving an input related to sanitary work progress. Specifically, FIG. 13 is a diagram illustrating an example of a second reception mode for receiving an input related to sanitary work progress. Note that the same points as those of the above-described reception mode (FIG. 9 or the like) are denoted by the same reference signs, and the description thereof will be omitted as appropriate.

A content CT13 illustrated in FIG. 13 is a content in which a button BT5 for indicating the start of sanitary work and an item for indicating whether sanitary work is required are added to the content CT12 illustrated in FIG. 9. FIG. 13 illustrates a case where the toilet room TB1 and the toilet room TB2 require sanitary work. The determination of whether sanitary work is required will be described below. For example, the control device 100 generates the content CT13, and transmits the generated content CT13 to the input device 30. The input device 30 displays the content CT13 received from the control device 100.

As illustrated in FIG. 13, the content CT13 includes the buttons BT1 to BT5 for receiving input. For example, the button BT5 is a button for receiving input of information indicating the start of operation. In FIG. 13, when the button BT5 is designated, the input device 30 transmits, to the control device 100, information indicating the start of operation (sanitary work operation start information) of the toilet rooms TB1 and TB2 in need of sanitary work among all the toilet rooms TB. The lavatory control system 1 may take a toilet room TB designated by an instruction of the administrator of the lavatory control system 1 as the toilet room TB in need of sanitary work. In this case, the control device 100 transmits information indicating the toilet room TB in need of sanitary work to an administrator's device used by the administrator, and receives information indicating the toilet room TB designated by the administrator from the administrator's device. In this case, the administrator's device used by the administrator displays the information received from the control device 100, and transmits, to the control device 100, the information indicating the toilet room TB designated by the administrator in response to an operation of designating the toilet room TB by the administrator.

Note that FIG. 13 is merely an example, and any mode can be adopted for the content CT13. For example, the content CT13 may include a button for receiving a start of sanitary work for each toilet room TB. In this case, the content CT13 may include three individual sanitary work start buttons respectively corresponding to the toilet rooms TB1 to TB3. In this case, when the individual sanitary work start button corresponding to the toilet room TB1 is designated, the input device 30 transmits, to the control device 100, information indicating that the sanitary work of the toilet room TB1 is to be started (sanitary work start information). When the individual sanitary work start button corresponding to the toilet room TB2 is designated, the input device 30 transmits, to the control device 100, information indicating that the sanitary work of the toilet room TB2 is to be started (sanitary work start information). The content CT13 need not include the item for indicating whether sanitary work is required.

### 1-6-4. Display of Non-Recommendation Information

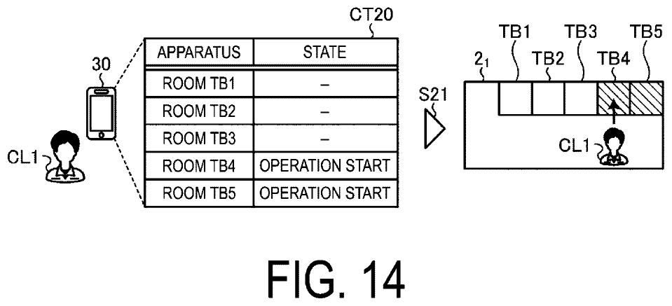

An overview of non-recommendation information display performed by the lavatory control system 1 will be described. First, an overview of processing will be described with reference to FIG. 14. FIG. 14 is a diagram illustrating an overview of processing relating to non-recommendation information display performed by the lavatory control system. In FIG. 14, a case where the five toilet rooms TB1 to TB5 of the toilet space 2₁ in FIG. 1 are sanitary work targets and the cleaner CL1 performs sanitary work on the sanitary work targets will be described as an example. Note that description of the same points as those described with reference to FIG. 6 and the like will be omitted as appropriate.

In FIG. 14, the cleaner CL1 plans to start the sanitary work of the toilet rooms TB4 and TB5 as sanitary work targets, and operates the input device 30, which is a smartphone carried by the cleaner CL1, to input therein sanitary work start information indicating that the sanitary work of the toilet rooms TB4 and TB5 is planned to be performed. In FIG. 14, the cleaner CL1 operates the input device 30, on which a content CT20 is displayed, and inputs sanitary work start information indicating that the sanitary work of the toilet rooms TB4 and TB5 is planned.

The content CT20 illustrated in FIG. 14 is displayed on the input device 30 used by the cleaner CL1. For example, the control device 100 generates the content CT20, and transmits the generated content CT20 to the input device 30 used by the cleaner CL1. The input device 30 used by the cleaner CL1 displays the content CT20 received from the control device 100. The content CT20 contains a list in which information indicating each of the toilet rooms TB1 to TB5 and information indicating states related to the sanitary work progress are associated with each other

Note that the content CT20 illustrated in FIG. 14 is merely an example, and the content CT20 may include a button for receiving an input of sanitary work start of each toilet room TB, for example, as the content CT12 illustrated in FIG. 9. In this case, when the cleaner CL1 designates buttons corresponding to the toilet rooms TB4 and TB5 in the content CT20, the input device 30 receives an input of the sanitary work start information indicating that the sanitary work of the toilet rooms TB4 and TB5 is planned to be performed. Then, the input device 30 transmits, to the control device 100, the information indicating that the sanitary work of the toilet rooms TB4 and TB5 is planned to be performed (sanitary work start information). Then, the input device 30 displays the content CT20, in which the states of the toilet rooms TB4 and TB5 are changed to completion. The input device 30 may receive an input of the sanitary work start information indicating that the sanitary work of the toilet rooms TB4 and TB5 is planned, through a sound input or the like by the cleaner CL1.

The control device 100 having received the sanitary work start information of the toilet rooms TB4 and TB5 from the input device 30 performs control to cause the displays 20₁₄ and 20₁₅ to display usage non-recommendation information indicating that the use of the toilet rooms TB4 and TB5, the sanitary work start information of which has been input, is not recommended (step S21). For example, the control device 100 controls the displays 20₁₄ and 20₁₅ of the toilet rooms TB4 and TB5 to be illuminated in a mode (non-recommendation mode) in a color (for example, red or the like) indicating usage non-recommendation. Thus, the displays 20₁₄ and 20₁₅ of the toilet rooms TB4 and TB5 are illuminated in the non-recommendation mode, and display the usage non-recommendation information indicating that the use of the toilet rooms TB4 and TB5 is not recommended.

In FIG. 14, regions corresponding to the toilet rooms TB4 and TB5 in the toilet space 2₁ are hatched (hatched with a different type pattern from that in FIG. 6) to indicate a state in which the displays 20₁₄ and 20₁₅ of the toilet rooms TB4 and TB5 are illuminated in the non-recommendation mode (for example, red). In a case where the display 20 can display an image or the like, a plan view corresponding to the state of the toilet space 2₁ in FIG. 14 (a diagram in which the regions of the toilet rooms TB4 and TB5 are colored in red, or the like) may be displayed.

When sanitary work of a toilet is to be performed, the sanitary work of the toilet cannot be performed in a case where the toilet is being used. Then, as described above, the lavatory control system 1 restricts the use of the room scheduled to be subjected to sanitary work, so that a possibility that the toilet room scheduled to be subjected to sanitary work is used can be reduced, thereby making it possible to improve the efficiency of the sanitary work operation.

### 1-6-5. Third Control

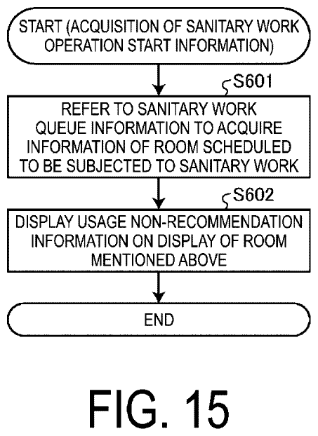

Next, third control by the lavatory control system 1 will be described with reference to FIGS. 15 to 18. A case will be described as an example in which processing is performed based on information indicating a queue for performing sanitary work (sanitary work queue information) of the plurality of sanitary work targets.

First, a processing flow of processing executed by the lavatory control system 1 will be described with reference to FIG. 15. FIG. 15 is a flowchart illustrating an example of a procedure for processing executed by the lavatory control system. Specifically, FIG. 15 is a flowchart illustrating an example of a procedure for the sixth processing executed by the lavatory control system 1.

First, in the sixth processing, sanitary work operation start information is acquired. For example, the control device 100 receives, from the input device 30, sanitary work operation start information indicating the start of sanitary work operation.

The lavatory control system 1 refers to the sanitary work queue information to acquire information of the room scheduled to be subjected to sanitary work (step S601). For example, the control device 100 refers to the sanitary work queue information, then sets a room scheduled for sanitary work at the top of the queue among the rooms scheduled to be subjected to sanitary work as the toilet room scheduled to be subjected to sanitary work (e.g., the toilet room TB1 or the like), and acquires room information indicating the set room.

The lavatory control system 1 displays usage non-recommendation information on the display of the room (step S602). For example, the control device 100 controls the display 20₁₁ of the toilet room TB1, which is a toilet room scheduled to be subjected to sanitary work, to be illuminated in the non-recommendation mode.

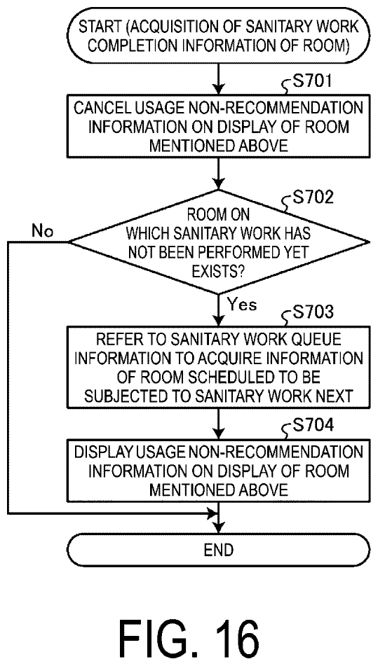

A processing flow of processing executed by the lavatory control system 1 will be described with reference to FIG. 16. FIG. 16 is a flowchart illustrating an example of a procedure for processing executed by the lavatory control system. Specifically, FIG. 16 is a flowchart illustrating an example of a procedure for the seventh processing executed by the lavatory control system 1.

First, in the seventh processing, the lavatory control system 1 acquires sanitary work completion information of a room. For example, the control device 100 receives sanitary work completion information of the toilet room TB1 from the input device 30.

The lavatory control system 1 cancels the usage non-recommendation information on the display of the room (step S701). For example, when the display 20₁₁ of the toilet room TB1 is being illuminated in the non-recommendation mode, the control device 100 performs control to cancel the illumination of the display 20₁₁ of the toilet room TB1 in the non-recommendation mode.

The lavatory control system 1 judges whether there is a room for which sanitary work has not been performed yet (step S702). For example, the control device 100 judges whether there is a room for which sanitary work has not been performed yet among the rooms scheduled to be subjected to sanitary work indicated by the sanitary work queue information.

When there is no room that has not been subjected to sanitary work (step S702: No), the lavatory control system 1 ends the seventh processing. For example, the control device 100 ends the seventh processing when there is no room that has not been subjected to sanitary work among the rooms scheduled to be subjected to sanitary work indicated by the sanitary work queue information.

When there is a room for which sanitary work has not been performed yet (step S702: Yes), the lavatory control system 1 refers to the sanitary work queue information to acquire information of the room scheduled to be subjected to sanitary work next (step S703). For example, the control device 100 refers to the sanitary work queue information, then sets a room waiting for sanitary work at the top of the queue among the rooms scheduled to be subjected to sanitary work as the toilet room scheduled to be subjected to sanitary work (e.g., the toilet room TB2 or the like), and acquires room information indicating the set room.

The lavatory control system 1 displays usage non-recommendation information on the display of the room (step S704). For example, the control device 100 controls the display 20₁₂ of the toilet room TB2, which is a toilet room scheduled to be subjected to sanitary work, to be illuminated in the non-recommendation mode.

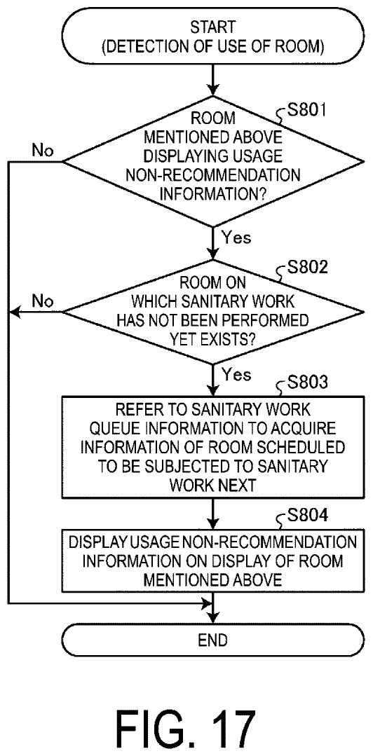

A processing flow of processing executed by the lavatory control system 1 will be described with reference to FIG. 17. FIG. 17 is a flowchart illustrating an example of a procedure for processing executed by the lavatory control system. Specifically, FIG. 17 is a flowchart illustrating an example of a procedure for the eighth processing executed by the lavatory control system 1.

First, in the eighth processing, the lavatory control system 1 detects use of a room. For example, the control device 100 receives detection information indicating the use of the toilet room TB2 from the detection unit 101₁₂ of the toilet room TB2.

The lavatory control system 1 judges whether the room is displaying usage non-recommendation information (step S801). For example, the control device 100 judges whether the display 20₁₂ of the toilet room TB2 is illuminated in the non-recommendation mode.

The lavatory control system 1 ends the eighth processing when the room is not displaying usage non-recommendation information (step S801: No). For example, when it is judged that the display 20₁₂ of the toilet room TB2 is not illuminated in the non-recommendation mode, the control device 100 ends the eighth processing.

When the room is displaying the usage non-recommendation information (step S801: Yes), the lavatory control system 1 judges whether there is a room in which no sanitary work has been performed (step S802). For example, when it is judged that the display 20₁₂ of the toilet room TB2 is illuminated in the non-recommendation mode, the control device 100 judges whether there is a room in which no sanitary work has been performed among the rooms scheduled to be subjected to sanitary work indicated by the sanitary work queue information.

When there is no room that has not been subjected to sanitary work (step S802: No), the lavatory control system 1 ends the eighth processing. For example, the control device 100 ends the eighth processing when there is no room that has not been subjected to sanitary work among the rooms scheduled to be subjected to sanitary work indicated by the sanitary work queue information.

When there is a room in which no sanitary work has been performed (step S802: Yes), the lavatory control system 1 refers to the sanitary work queue information to acquire information of the room scheduled to be subjected to sanitary work next (step S803). For example, the control device 100 refers to the sanitary work queue information, then sets a room scheduled for sanitary work at the top of the queue among the rooms scheduled to be subjected to sanitary work as the toilet room scheduled to be subjected to sanitary work (e.g., the toilet room TB3 or the like), and acquires room information indicating the set room. The lavatory control system 1 displays usage non-recommendation information on the display of the room (step S804). For example, the control device 100 controls the display 20₁₃ of the toilet room TB3, which is a toilet room scheduled to be subjected to sanitary work, to be illuminated in the non-recommendation mode.

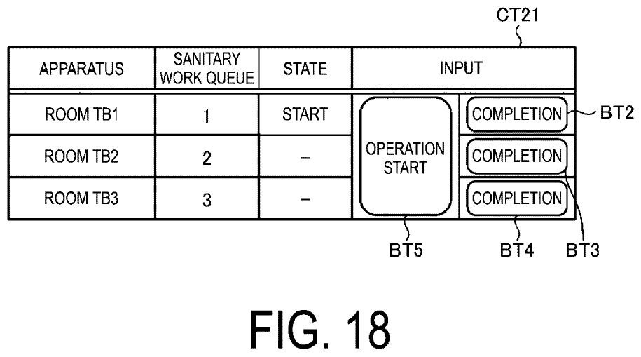

Here, an example of a mode for receiving an input will be described with reference to FIG. 18. FIG. 18 is a diagram illustrating an example of a mode for receiving an input related to sanitary work progress. Specifically, FIG. 18 is a diagram illustrating an example of a third reception mode for receiving an input related to sanitary work progress. Note that the same points as those of the above-described reception mode (FIG. 9 or the like) are denoted by the same reference signs, and the description thereof will be omitted as appropriate.

A content CT21 illustrated in FIG. 18 is a content in which an item of the sanitary work queue is added to the content CT12 illustrated in FIG. 9. For example, the control device 100 generates the content CT21, and transmits the generated content CT21 to the input device 30. The input device 30 displays the content CT21 received from the control device 100.

As illustrated in FIG. 18, the content CT21 includes information indicating that the toilet room TB1, toilet room TB2, and toilet room TB3 are queued in this order in the sanitary work queue. The cleaner who has checked the sanitary work queue performs operation on the toilet rooms TB as sanitary work targets in accordance with the sanitary work queue.

### 1-6-6. Fourth Control

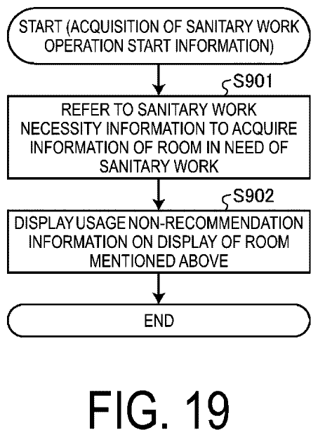

Next, fourth control by the lavatory control system 1 will be described with reference to FIGS. 19 to 22. First, a processing flow of processing executed by the lavatory control system 1 will be described with reference to FIG. 19. FIG. 19 is a flowchart illustrating an example of a procedure for processing executed by the lavatory control system. Specifically, FIG. 19 is a flowchart illustrating an example of a procedure of the ninth processing executed by the lavatory control system 1.

First, in the ninth processing, sanitary work operation start information is acquired. For example, the control device 100 receives, from the input device 30, sanitary work operation start information indicating the start of sanitary work operation.

The lavatory control system 1 refers to sanitary work necessity information to acquire information of a room in need of sanitary work (step S901). For example, the control device 100 refers to the sanitary work necessity information, and acquires room information indicating a room (for example, the toilet room TB1 or the like) judged to be in need of sanitary work. For example, the control device 100 generates the sanitary work necessity information by using information used for determining the necessity of sanitary work (also referred to as “sanitary work determining information”). The sanitary work determining information will be described below.

The lavatory control system 1 displays usage non-recommendation information on the display of the room (step S902). For example, the control device 100 controls the display 20₁₁ of the toilet room TB1, which is a toilet room scheduled to be subjected to sanitary work, to be illuminated in the non-recommendation mode.

### 1-6-7. Sanitary Work Determining Information

The information that the lavatory control system 1 uses for determining (judging) the necessity of sanitary work (sanitary work determining information) may be any type of information as long as the information can be used for determining the sanitary work, and may be information as follows, for example.

The sanitary work determining information may be information indicating dirt on the sanitary work target. For example, the sanitary work determining information may be information such as the number of times of use after sanitary work or the cumulative use time. In this case, the lavatory control system 1 may determine (judge) that the sanitary work target is dirtier as the number of times of use is larger and the cumulative use time is longer after the last sanitary work. For example, the lavatory control system 1 may determine that the sanitary work target needs sanitary work when at least one of the number of times of use or the cumulative use time after the last sanitary work is equal to or greater than a predetermined value.

For example, the sanitary work determining information may be an elapsed time from the sanitary work. In this case, the lavatory control system 1 may determine that the longer the elapsed time from the last sanitary work, the dirtier the sanitary work target. For example, the lavatory control system 1 may determine that the sanitary work target needs sanitary work when the elapsed time from the last sanitary work is equal to or greater than a predetermined value.

For example, the sanitary work determining information may be detection information (sensor value) by an odor sensor (gas sensor). In this case, the lavatory control system 1 may determine that the larger the sensor value indicating the degree of the odor, the dirtier the sanitary work target. For example, the lavatory control system 1 may determine that the sanitary work target needs sanitary work when the sensor value of the odor sensor (gas sensor) is equal to or greater than a predetermined value.

For example, the sanitary work determining information may be detection information (sensor value) obtained by detecting the amount of trash in a trash box by a distance measurement sensor. In this case, the lavatory control system 1 may determine that larger the sensor value indicating the amount of trash in the trash box, the dirtier the sanitary work target. For example, the lavatory control system 1 may determine that the sanitary work target needs sanitary work when the sensor value of the distance measurement sensor is equal to or greater than a predetermined value.

The sanitary work determining information may be information indicating abnormality of a sanitary work target. For example, the sanitary work determining information may be detection information by a water leakage detection sensor. In this case, when the detection information by the water leakage detection sensor indicates water leakage, the lavatory control system 1 may determine that the sanitary work target is in a state different from a normal state. In this case, when the detection information by the water leakage detection sensor indicates water leakage, the lavatory control system 1 may determine that the sanitary work target needs sanitary work.

For example, the sanitary work determining information may be detection information by a sensor (clogging detection sensor) configured to detect clogging of a toilet bowl or piping. In this case, when the detection information by the clogging detection sensor indicates clogging, the lavatory control system 1 may determine that the sanitary work target is in a state different from the normal state. For example, when the detection information by the clogging detection sensor indicates clogging, the lavatory control system 1 may determine that the sanitary work target needs sanitary work.

For example, the sanitary work determining information may be detection information by a sensor (abnormality detection sensor) configured to detect an abnormal temperature of a toilet seat or a tank, malfunction of a remote control, or the like. In this case, when the detection information by the abnormality detection sensor indicates abnormality, the lavatory control system 1 may determine that the sanitary work target is in a state different from the normal state. For example, when the detection information by the abnormality detection sensor indicates abnormality, the lavatory control system 1 may determine that the sanitary work target needs sanitary work.

For example, the sanitary work determining information may be information (use information) related to the use of a sanitary work target. In this case, when the use information indicates that the sanitary work target has not been used for a long period of time, the lavatory control system 1 may determine that the sanitary work target is in a state different from the normal state. For example, when the use information indicates that the sanitary work target has not been continuously used for equal to or longer than a predetermined period of time, the lavatory control system 1 may determine that the sanitary work target needs sanitary work.

For example, the sanitary work determining information may be information (residual amount information) regarding the residual amount of consumables in a sanitary work target. In this case, when the residual amount indicated by the residual amount information indicates that replenishment is needed, the lavatory control system 1 may determine that the sanitary work target is in a state different from the normal state. For example, the lavatory control system 1 may determine that the sanitary work target needs sanitary work when the residual amount indicated by the residual amount information is equal to or smaller than a predetermined amount.

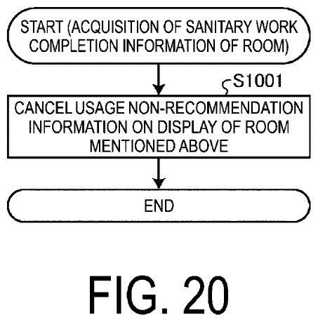

Hereinafter, a processing flow of processing executed by the lavatory control system 1 will be described with reference to FIG. 20. FIG. 20 is a flowchart illustrating an example of a procedure for processing executed by the lavatory control system. Specifically, FIG. 20 is a flowchart illustrating an example of a procedure for the tenth processing executed by the lavatory control system 1.

First, in the tenth processing, sanitary work completion information of a room is acquired. For example, the control device 100 receives, from the input device 30, sanitary work completion information indicating the sanitary work completion of the toilet room TB1.

The lavatory control system 1 cancels the usage non-recommendation information on the display of the room (step S1001). For example, when the display 20₁₁ of the toilet room TB1 is being illuminated in the non-recommendation mode, the control device 100 performs control to cancel the illumination of the display 20₁₁ of the toilet room TB1 in the non-recommendation mode.

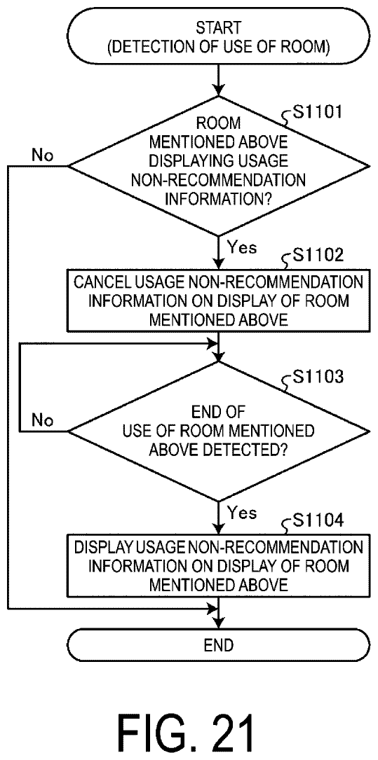

Hereinafter, a processing flow of processing executed by the lavatory control system 1 will be described with reference to FIG. 21. FIG. 21 is a flowchart illustrating an example of a procedure for processing executed by the lavatory control system. Specifically, FIG. 21 is a flowchart illustrating an example of a procedure for the eleventh processing executed by the lavatory control system 1.

First, in the eleventh processing, the lavatory control system 1 detects use of a room. For example, the control device 100 receives detection information indicating the use of the toilet room TB2 from the detection unit 101₁₂ of the toilet room TB2.

The lavatory control system 1 judges whether the room is displaying usage non-recommendation information (step S1101). For example, the control device 100 judges whether the display 20₁₂ of the toilet room TB2 is illuminated in the non-recommendation mode. The lavatory control system 1 ends the eleventh processing when the room is not displaying usage non-recommendation information (step S1101: No). For example, when it is judged that the display 20₁₂ of the toilet room TB2 is not illuminated in the non-recommendation mode, the control device 100 ends the eleventh processing.

When the room is displaying usage non-recommendation information (step S1101: Yes), the lavatory control system 1 cancels the usage non-recommendation information on the display of the room (step S1102). For example, when the display 20₁₂ of the toilet room TB2 is being illuminated in the non-recommendation mode, the control device 100 performs control of canceling the illumination of the display 20₁₂ of the toilet room TB2 in the non-recommendation mode.

The lavatory control system 1 judges whether the end of use of the room is detected (step S1103). For example, the control device 100 judges whether the use of the toilet room TB2 has ended based on detection information received from the detection unit 101₁₂ of the toilet room TB2.

When the end of use of the room has not been detected (step S1103: No), the lavatory control system 1 repeats the processing of step S1103. For example, when it is judged that the use of the toilet room TB2 has not ended, the control device 100 repeats the processing of step S1103.

When the end of use of the room is detected (step S1103: Yes), the lavatory control system 1 displays usage non-recommendation information on the display of the room (step S1104). For example, the control device 100 controls the display 20₁₂ of the toilet room TB2, which is a toilet room scheduled to be subjected to sanitary work, to be illuminated in the non-recommendation mode.

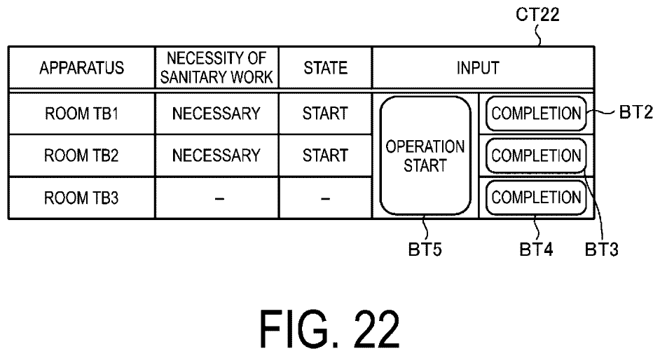

Here, an example of a mode for receiving an input will be described with reference to FIG. 22. FIG. 22 is a diagram illustrating an example of a mode for receiving an input related to sanitary work progress. Specifically, FIG. 22 is a diagram illustrating an example of a fourth reception mode for receiving an input related to sanitary work progress. Note that the same points as those of the above-described reception mode (FIG. 13 or the like) are denoted by the same reference signs, and the description thereof will be omitted as appropriate.

A content CT22 illustrated in FIG. 22 is a content in which the button BT1 is removed from the content CT13 illustrated in FIG. 13. For example, the control device 100 generates the content CT22, and transmits the generated content CT22 to the input device 30. The input device 30 displays the content CT22 received from the control device 100.

### 1-6-8. Fifth Control

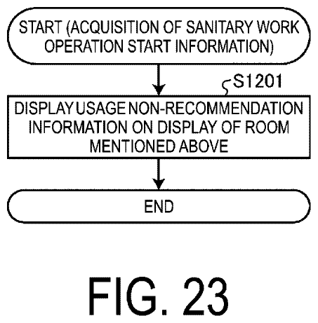

Hereinafter, fifth control by the lavatory control system 1 will be described with reference to FIGS. 23 to 26. Specifically, in the fifth control, a case will be described as an example in which a room scheduled to be subjected to sanitary work is set to be not recommended, and set to be recommended upon completion of the sanitary work. When processing of only the fifth control is executed, the lavatory control system 1 is allowed not to include the detection unit 101. That is, when the processing of only the fifth control is executed, the lavatory control system 1 need not include the detection unit 101 provided in association with each toilet room TB in FIG. 2.

First, a processing flow of processing executed by the lavatory control system 1 will be described with reference to FIG. 23. FIG. 23 is a flowchart illustrating an example of a procedure for processing executed by the lavatory control system. Specifically, FIG. 23 is a flowchart illustrating an example of a procedure for the twelfth processing executed by the lavatory control system 1.

First, in the twelfth processing, sanitary work operation start information is acquired. For example, the control device 100 receives, from the input device 30, sanitary work operation start information indicating the start of sanitary work operation of the toilet room TB1.

The lavatory control system 1 displays usage non-recommendation information on the display of the room (step S1201). For example, the control device 100 controls the display 20₁₁ of the toilet room TB1 to be illuminated in a mode (non-recommendation mode) in a color (for example, red or the like) indicating usage non-recommendation.

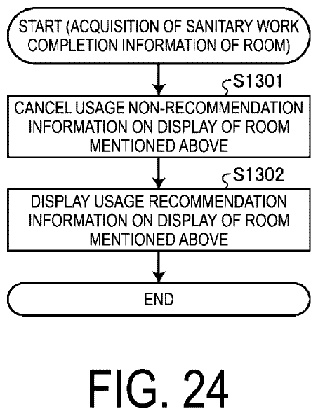

Hereinafter, a processing flow of processing executed by the lavatory control system 1 will be described with reference to FIG. 24. FIG. 24 is a flowchart illustrating an example of a procedure for processing executed by the lavatory control system. Specifically, FIG. 24 is a flowchart illustrating an example of a procedure for the thirteenth processing executed by the lavatory control system 1.

First, in the thirteenth processing, sanitary work completion information of a room is acquired. For example, the control device 100 receives, from the input device 30, sanitary work completion information indicating the sanitary work completion of the toilet room TB1.

The lavatory control system 1 cancels the usage non-recommendation information on the display of the room (step S1301). For example, when the display 20₁₁ of the toilet room TB1 is being illuminated in the non-recommendation mode, the control device 100 performs control to cancel the illumination of the display 20₁₁ of the toilet room TB1 in the non-recommendation mode.

The lavatory control system 1 displays usage recommendation information on the display of the room (step S1302). For example, the control device 100 controls the display 20₁₁ of the toilet room TB1 to be illuminated in the recommendation mode.

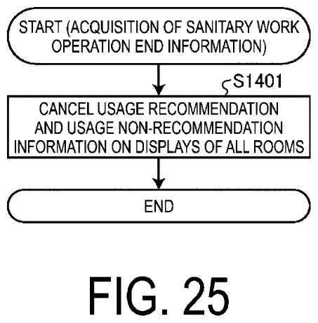

Hereinafter, a processing flow of processing executed by the lavatory control system 1 will be described with reference to FIG. 25. FIG. 25 is a flowchart illustrating an example of a procedure for processing executed by the lavatory control system. Specifically, FIG. 25 is a flowchart illustrating an example of a procedure for the fourteenth processing executed by the lavatory control system 1.

First, in the fourteenth processing, sanitary work operation end information is acquired. For example, the control device 100 receives, from the input device 30, sanitary work operation end information indicating the end of the sanitary work operation of all the toilet rooms TB as sanitary work targets.

The lavatory control system 1 cancels the usage recommendation and usage non-recommendation information on the displays of all the rooms (step S1401). For example, the control device 100 performs control of canceling the illumination of the displays 20 of all the toilet rooms TB, with respect to the displays 20 being illuminated in the recommendation mode or non-recommendation mode.

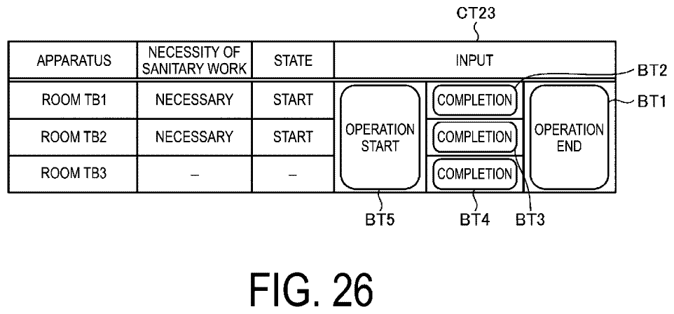

Here, an example of a mode for receiving an input will be described with reference to FIG. 26. FIG. 26 is a diagram illustrating an example of a mode for receiving an input related to sanitary work progress. Specifically, FIG. 262 is a diagram illustrating an example of a fifth reception mode for receiving an input related to sanitary work progress. Note that the same points as those of the above-described reception mode (FIG. 9 or the like) are denoted by the same reference signs, and the description thereof will be omitted as appropriate.

A content CT23 illustrated in FIG. 26 is a content similar to the content CT13 illustrated in FIG. 13. For example, the control device 100 generates the content CT23, and transmits the generated content CT23 to the input device 30. The input device 30 displays the content CT23 received from the control device 100.

### 1-6-9. Display of Recommendation Information and Non-Recommendation Information

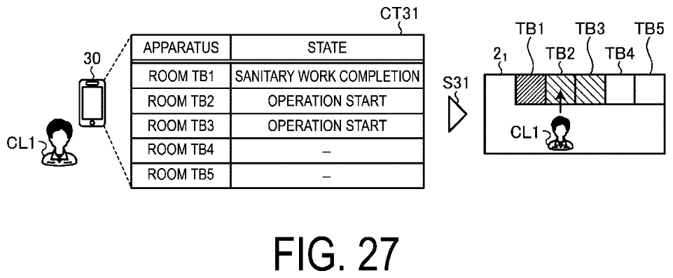

The lavatory control system 1 may display both recommendation information and non-recommendation information together. Regarding this point, an overview of processing will be described below with reference to FIG. 27. FIG. 27 is a diagram illustrating an overview of processing relating to display of recommendation information and non-recommendation information performed by the lavatory control system. In FIG. 27, a case will be described as an example in which the five toilet rooms TB1 to TB5 of the toilet space 2₁ in FIG. 1 are sanitary work targets and the cleaner CL1 performs sanitary work on the sanitary work targets. Note that description of the same points as those described with reference to FIG. 6, FIG. 14, and the like will be omitted as appropriate.

FIG. 27 illustrates a case as an example in which the cleaner CL1 has completed the sanitary work of the toilet room TB1, and plans to start the sanitary work of the toilet rooms TB2 and TB3. The cleaner CL1 operates the input device 30, which is a smartphone carried by the cleaner CL1, to input the sanitary work completion information of the toilet room TB1 to the input device 30 as the input terminal, and inputs the sanitary work start information of the toilet rooms TB2 and TB3. FIG. 27 illustrates a case where the sanitary work completion information and the sanitary work start information are collectively input at the same timing for the sake of simplicity of description, but the sanitary work completion information and the sanitary work start information may be individually input at different timings.

A content CT31 illustrated in FIG. 27 is displayed on the input device 30 used by the cleaner CL1. For example, the control device 100 generates the content CT31, and transmits the generated content CT31 to the input device 30 used by the cleaner CL1. The input device 30 used by the cleaner CL1 displays the content CT31 received from the control device 100. The content CT31 contains a list in which information indicating each of the toilet rooms TB1 to TB5 and information indicating states related to the sanitary work progress are associated with each other. The reception of the input by the input device 30 and the transmission of the information to the control device 100 are the same as those in FIG. 6, FIG. 14, and the like, and therefore the detailed description thereof will be omitted.

The control device 100 having received the sanitary work completion information of the toilet room TB1 and the sanitary work start information of the toilet rooms TB2 and TB3 from the input device 30 performs control in accordance with the acquired information (step S31). In FIG. 27, the control device 100 performs control of display of recommendation information regarding the toilet room TB1 and display of non-recommendation information regarding the toilet rooms TB2 and TB3.

The control device 100 having received the sanitary work completion information of the toilet room TB1 performs control to cause the display 20₁₁ to display usage recommendation information that recommends use of the toilet room TB1, the sanitary work completion information of which has been input. For example, the control device 100 controls the display 2011 of the toilet room TB1 to be illuminated in a mode (recommendation mode) in a color (for example, blue or the like) indicating usage recommendation. Then, the display 20₁₁ of the toilet room TB1 is illuminated in the recommendation mode, and displays the usage recommendation information indicating that the use of the toilet room TB1 is recommended. In FIG. 27, a region corresponding to the toilet room TB1 in the toilet space 2₁ is hatched with a first type of hatching to indicate a state in which the display 20₁₁ of the toilet room TB1 is illuminated in the recommendation mode (for example, blue).

The control device 100 having received the sanitary work start information of the toilet rooms TB2 and TB3 performs control to cause the displays 20₁₂ and 20₁₃ to display usage non-recommendation information indicating that the use of the toilet rooms TB2 and TB3, the sanitary work start information of which has been input, is not recommended. For example, the control device 100 controls the displays 20₁₂ and 20₁₃ of the toilet rooms TB2 and TB3 to be illuminated in a mode (non-recommendation mode) in a color (for example, red or the like) indicating usage non-recommendation. Thus, the displays 20₁₂ and 20₁₃ of the toilet rooms TB2 and TB3 are illuminated in the non-recommendation mode, and display the usage non-recommendation information indicating that the use of the toilet rooms TB2 and TB3 is not recommended.

In FIG. 27, regions corresponding to the toilet rooms TB2 and TB3 in the toilet space 2₁ are hatched with a second type of hatching different from the first type of hatching to indicate a state in which the displays 20₁₂ and 20₁₃ of the toilet rooms TB2 and TB3 are illuminated in the non-recommendation mode (for example, red). In a case where the display 20 can display an image or the like, a plan view corresponding to the state of the toilet space 2₁ in FIG. 27 (a diagram in which the region corresponding to the toilet room TB1 is colored in blue and the regions corresponding to the toilet rooms TB2 and TB3 are colored in red, or the like) may be displayed.

When sanitary work of a toilet is to be performed, the sanitary work of the toilet cannot be performed in case where the toilet is being used. Therefore, as described above, by recommending the user to use a toilet room, the sanitary work of which has been completed, and recommending the user not to use a toilet room scheduled to be subjected to sanitary work, the lavatory control system 1 can reduce a possibility that a toilet room scheduled to be subjected to sanitary work is used, thereby making it possible to improve the efficiency of the sanitary work operation.

### 1-6-10. Examples of Other Sanitary Work Targets (Toilet Spaces)

In the above-described examples, the toilet room TB has been described as an example of the sanitary work target, but the sanitary work target may be the toilet space 2. In the case where the sanitary work target is the toilet space 2, the lavatory control system 1 recommends the user to use the toilet space 2, the sanitary work of which has been completed, and does not recommend the user to use the toilet space 2 scheduled to be subjected to the sanitary work, thereby making it possible to improve the efficiency of the sanitary work of the toilet space 2 as the sanitary work target.

In this case, the display 20 may be disposed for each toilet space 2, and for example, the display 20 may be disposed at the entrance of each toilet space 2. The display 20 may be disposed at the entrance or the like of a facility where the toilet space 2 to serve as the sanitary work target is provided.

As described above, in the case where the sanitary work target is the toilet space 2, when the sanitary work completion information of the toilet space 2 is input to the input device 30, the control device 100 performs control to cause the display 20 to display usage recommendation information that recommends use of the target toilet space that is the toilet space 2, the sanitary work completion information of which has been input.

In the case where the sanitary work target is the toilet space 2, when sanitary work start information of the toilet space 2 is input to the input device 30, the control device 100 performs control to cause the display 20 to display usage non-recommendation information indicating that use of a designated toilet space that is the toilet space 2 designated by the sanitary work start information is not recommended, and also performs control to cancel the display of the usage non-recommendation information of the designated toilet space by the display 20 when sanitary work completion information of the designated toilet space is input to the input device 30. Except for the fact that the sanitary work target is changed from the toilet room TB to the toilet space 2, the processing executed by the lavatory control system 1 when the sanitary work target is the toilet space 2 is the same as the processing executed by the lavatory control system 1 when the sanitary work target is the toilet room TB described above, and therefore detailed description thereof will be omitted.

Note that the above-described embodiments and modifications can be combined as appropriate in a range without causing any contradiction in processing content.

Further effects and modifications can be easily derived by a person having skill in the art. Thus, broader aspects of the present invention are not limited to the specific details and representative embodiments illustrated and described above. Accordingly, various modifications may be made without departing from the spirit or scope of the general inventive concept as defined by the appended claims and their equivalents.

The embodiments and the modifications described above may have the following configurations, but the configurations thereof are not limited to the following configurations.

(1)

A lavatory control system used for a lavatory including a plurality of toilet rooms, the system comprising:
an input terminal configured to receive an input related to sanitary work progress for one toilet room:
a display configured to display a first sign that indicates that said one toilet room is suitable for use or a second sign that indicates that said one toilet room is unsuitable for use;
a controller programmed to control the display, in response to the input related to the sanitary work progress, through the input terminal, to display the first or second sign.
   (2)

The lavatory control system according to (1), wherein the input, through the input terminal, includes an end notice input to notify an end of sanitary work for said one toilet room, and the controller is programmed to, upon receipt of the end notice input, control the display to turn on the first sign for said one toilet room.

(3)

The lavatory control system according to (2), wherein the display is provided for each of the plurality of toilet rooms, and the controller is programmed to selectively control the displays to turn on the first sign for said one toilet room.

(4)

The lavatory control system according to (2) or (3), wherein the controller is further programmed to turn off the first sign for said one toilet room, upon an elapse of a predetermined time.

(5)

The lavatory control system according to any one of (2) to (4), wherein the controller is programmed to turn off the first sign for at least some of the plurality of toilet rooms for which the first sign is turned on, upon receipt of the end notice for the plurality of toilet rooms.

(6)

The lavatory control system according to any one of (2) to (5), wherein the controller is programmed to turn off the first sign for a toilet room for which the first sign is turned on, when the toilet room becomes in use.

(7)

The lavatory control system according to (6), wherein the controller is programmed to turn back on the first sign when the toilet room is released from the use.

(8)

A lavatory control system for a lavatory including a plurality of toilet spaces, the system comprising:
an input terminal configured to receive an input related to sanitary work progress for the plurality of toilet spaces, wherein the input includes an end notice input to notify an end of sanitary work for one toilet space:
a display configured to display a first sign that indicates that said one toilet space is suitable for use or a second sign that indicates that said one toilet space is unsuitable for use;
a controller programmed to control the display to, in response to receipt of the end notice input, through the input terminal, turn on the first sign for the said one toilet space.
   (9)

The lavatory control system according to (1), wherein the input includes a start notice input to notify a start of sanitary work and an end notice input to notify an end of the sanitary work, and the controller is programmed to turn on the second sign for a designated toilet room upon receipt of the start notice identifying the designated toilet room and turn off the second sign for the designated toilet room upon receipt of the end notice identifying the designated toilet room.

(10)

The lavatory control system according to (1), wherein the sanitary work progress includes a room queue for performing the sanitary work on the plurality of toilet rooms, and the controller is programmed to, upon receipt of the end notice identifying a designated toilet room, turn on the second sign for toilet rooms subsequent in the room queue to the designated toilet room.

(11)

The lavatory control system according to (9) or (10), wherein the display is provided for each of the plurality of toilet rooms, and the controller is programmed to selectively control the displays to turn on the second sign for the designated toilet room.

(12)

The lavatory control system according to any one of (9) to (11), further comprising a sensor provided for each of the plurality of toilet rooms and operable to sense use of the toilet room for which the sensor is provided, and the controller is programmed to, upon sensing by the sensor of a first toilet room, for which the second sign is turned on, becoming in use, turn on the second sign for a second toilet room different from the first toilet room.

(13)

The lavatory control system according to any one of (9) to (12), wherein the controller is programmed to identify a toilet room that needs the sanitary work and selectively control the displays to turn on the second sign for the identified toilet room.

(14)

The lavatory control system according to any one of (9) to (13), wherein the controller is programmed to, upon sensing by the sensor of one of the plurality of toilet rooms, for which the second sign is turned on, becoming in use, turn off the second sign for said one of the plurality of toilet rooms.

(15)

The lavatory control system according to (14), wherein the controller is programmed to turn back on the second sign for said one of the plurality of toilet rooms, upon an end of the use of said one of the plurality of toilet rooms.

(16)

A lavatory control system for a lavatory including a plurality of toilet spaces, the system comprising:
an input terminal configured to receive an input related to sanitary work progress for the plurality of toilet spaces, wherein the input includes a start notice input to notify a start of sanitary work and an end notice input to notify an end of the sanitary work:
a display configured to display a sign that indicates that a particular toilet space is unsuitable for use;
a controller programmed to control the display, in response to receipt of the start notice input, through the input terminal, to turn on the sign for the particular toilet room and, upon receipt of the end notice input, through the input terminal, to turn off the sign for the particular toilet room.

### REFERENCE SIGNS LIST

1 Lavatory control system
2 Toilet space (Toilet chamber)
10 Toilet bowl device
20 Display
30 Input device
50 Washstand
100 Control device (Information processing apparatus)
101 Detection unit
110 Communicator
120 Storage
121 Arrangement information storage unit
122 Control information storage unit
130 Controller
131 Acquisition unit
132 Judgment unit
133 Transmission unit
CS Common space
TB Toilet room

1. A lavatory control system used for a lavatory including a plurality of toilet rooms, the system comprising:
an input terminal configured to receive an input related to sanitary work progress for one toilet room:
a display configured to display a first sign that indicates that said one toilet room is suitable for use or a second sign that indicates that said one toilet room is unsuitable for use;
a controller programmed to control the display, in response to the input related to the sanitary work progress, through the input terminal, to display the first or second sign.

2. The lavatory control system according to claim 1, wherein the input, through the input terminal, includes an end notice input to notify an end of sanitary work for said one toilet room, and the controller is programmed to, upon receipt of the end notice input, control the display to turn on the first sign for said one toilet room.

3. The lavatory control system according to claim 2, wherein the display is provided for each of the plurality of toilet rooms, and the controller is programmed to selectively control the displays to turn on the first sign for said one toilet room.

4. The lavatory control system according to claim 2, wherein the controller is further programmed to turn off the first sign for said one toilet room, upon an elapse of a predetermined time.

5. The lavatory control system according to claim 2, wherein the controller is programmed to turn off the first sign for at least some of the plurality of toilet rooms for which the first sign is turned on, upon receipt of the end notice for the plurality of toilet rooms.

6. The lavatory control system according to claim 2, wherein the controller is programmed to turn off the first sign for a toilet room for which the first sign is turned on, when the toilet room becomes in use.

7. The lavatory control system according to claim 6, wherein the controller is programmed to turn back on the first sign when the toilet room is released from the use.

8. A lavatory control system for a lavatory including a plurality of toilet spaces, the system comprising:
an input terminal configured to receive an input related to sanitary work progress for the plurality of toilet spaces, wherein the input includes an end notice input to notify an end of sanitary work for one toilet space:
a display configured to display a first sign that indicates that said one toilet space is suitable for use or a second sign that indicates that said one toilet space is unsuitable for use;
a controller programmed to control the display to, in response to receipt of the end notice input, through the input terminal, turn on the first sign for the said one toilet space.

9. The lavatory control system according to claim 1, wherein the input includes a start notice input to notify a start of sanitary work and an end notice input to notify an end of the sanitary work, and the controller is programmed to turn on the second sign for a designated toilet room upon receipt of the start notice identifying the designated toilet room and turn off the second sign for the designated toilet room upon receipt of the end notice identifying the designated toilet room.

10. The lavatory control system according to claim 9, wherein the sanitary work progress includes a room queue for performing the sanitary work on the plurality of toilet rooms, and the controller is programmed to, upon receipt of the end notice identifying a designated toilet room, turn on the second sign for toilet rooms subsequent in the room queue to the designated toilet room.

11. The lavatory control system according to claim 9, wherein the display is provided for each of the plurality of toilet rooms, and the controller is programmed to selectively control the displays to turn on the second sign for the designated toilet room.

12. The lavatory control system according to claim 9, further comprising a sensor provided for each of the plurality of toilet rooms and operable to sense use of the toilet room for which the sensor is provided, and the controller is programmed to, upon sensing by the sensor of a first toilet room, for which the second sign is turned on, becoming in use, turn on the second sign for a second toilet room different from the first toilet room.

13. The lavatory control system according to claim 9, wherein the controller is programmed to identify a toilet room that needs the sanitary work and selectively control the displays to turn on the second sign for the identified toilet room.

14. The lavatory control system according to claim 12, wherein the controller is programmed to, upon sensing by the sensor of one of the plurality of toilet rooms, for which the second sign is turned on, becoming in use, turn off the second sign for said one of the plurality of toilet rooms.

15. The lavatory control system according to claim 14, wherein the controller is programmed to turn back on the second sign for said one of the plurality of toilet rooms, upon an end of the use of said one of the plurality of toilet rooms.

16. A lavatory control system for a lavatory including a plurality of toilet spaces, the system comprising:
an input terminal configured to receive an input related to sanitary work progress for the plurality of toilet spaces, wherein the input includes a start notice input to notify a start of sanitary work and an end notice input to notify an end of the sanitary work:
a display configured to display a sign that indicates that a particular toilet space is unsuitable for use;
a controller programmed to control the display, in response to receipt of the start notice input, through the input terminal, to turn on the sign for the particular toilet room and, upon receipt of the end notice input, through the input terminal, to turn off the sign for the particular toilet room.
